(19) United States
(12) Patent Application Publication
(10) Pub. No.: US 2025/0178057 A1
(43) Pub. Date: Jun. 5, 2025

(54) EXTRUSION CONFORMAL COOLING DEVICES, METHODS, AND SYSTEMS

(71) Applicant: The Regents of the University of Michigan, Ann Arbor, MI (US)

(72) Inventors: Daniel Ross Cooper, Ann Arbor, MI (US); Ala'aldin Alafaghani, Ann Arbor, MI (US)

(21) Appl. No.: 18/842,232

(22) PCT Filed: Feb. 28, 2023
(86) PCT No.: PCT/US2023/014119

§ 371 Date: Aug. 28, 2024

Related U.S. Application Data
(60) Provisional application No. 63/314,762, filed on Feb. 28, 2022.

(51) Int. Cl. B21C 29/04; B21C 25/04

(52) U.S. Cl. CPC B21C 29/04; B21C 25/04

(57) ABSTRACT

A die assembly includes an inflow end, an outflow end opposite the inflow end, and an internal cavity extending from the inflow end to the outflow end. The die assembly also includes an internal mandrel disposed within the internal cavity. The internal mandrel has an end proximate to the outflow end of the die assembly. The die assembly also includes an internal cooling channel within the internal mandrel. The internal cooling channel has an outlet at or near the end of the internal mandrel.

This application claims the benefit of U.S. provisional application entitled “Extrusion Conformal Cooling Devices, Methods, and Systems,” filed Feb. 28, 2022, and assigned Ser. No. 63/314,762, the entire disclosure of which is hereby expressly incorporated by reference.

### BACKGROUND OF THE DISCLOSURE

### Field of the Disclosure

The disclosure relates generally to devices, methods, and systems for cooling extruded profiles.

### Brief Description of Related Technology

Metal extrusion is a method of manufacturing metal components. During metal extrusion, a block of the extrusion metal, or billet, having a certain cross section and length starts off as a work piece in an extrusion chamber and is forced to flow through a die of a same or smaller cross-sectional area, thus forming the billet into a new cross section or profile. Numerous cross sections are manufactured by this method. The cross section or profile produced will be uniform over the entire length of the metal extrusion. In one example, a cylindrical billet may be formed into a round part of smaller diameter, a hollow tube, or some other profile. Billets of other shapes are possible.

Although metal extrusion is possible at room temperature, it is often performed while the billet is at an elevated temperature. Extruding the metal billet while it is at an elevated temperature decreases the yield strength of the metal billet, which leads to a reduction in the force required to pass the metal billet through the die of a smaller cross-sectional area. The temperature of the material may further increase due to the plastic deformation of the billet as it flows through the extrusion die. The temperature increase during extrusion can be used to transform heat treatable metal alloys into single phase solid solutions ready for subsequent heat treatment. Heat treatable metal alloys can be quenched using a fluid as they leave the extrusion die to transform the metal from a single phase solid solution to a supersaturated solid solution ready for subsequent ageing.

Recently, metal extrusion has increasingly been used to manufacture complex extruded profiles including multiple internal voids and from quench sensitive alloys.

### SUMMARY OF THE DISCLOSURE

In accordance with one aspect of the present disclosure, a die assembly includes an inflow end, an outflow end opposite the inflow end, and an internal cavity extending from the inflow end to the outflow end. The die assembly also includes an internal mandrel disposed within the internal cavity. The internal mandrel has an end proximate to the outflow end of the die assembly. The die assembly also includes an internal cooling channel within the internal mandrel. The internal cooling channel has an outlet at or near the end of the internal mandrel.

In accordance with another aspect of the present disclosure, a method of cooling an extruded profile with a die assembly, the die assembly including an inflow end, an outflow end opposite the inflow end, an internal cavity extending from the inflow end to the outflow end, an internal mandrel disposed within the internal cavity, the internal mandrel having an end proximate to the outflow end of the die assembly, and an internal cooling channel within the internal mandrel, the internal cooling channel extending from an inlet disposed on an exterior surface of the die assembly to an outlet disposed at or near the end of the internal mandrel, includes feeding a billet of material through the internal cavity of the die assembly such that the billet of material is extruded through the outflow end of the die assembly to form the extruded profile. The extruded profile has an interior hollow section formed by the internal mandrel. The method of cooling an extruded profile also includes supplying a fluid to the internal cooling channel. The internal cooling channel is configured to convey the fluid from the inlet to the outlet of the internal cooling channel, such that the fluid is dispersed at the outlet of the internal cooling channel within the internal mandrel into the interior hollow section of the extruded profile to cool the extruded profile.

In accordance with yet another aspect of the present disclosure, a system for cooling an extruded profile includes a die assembly. The die assembly includes an inflow end, an outflow end opposite the inflow end, and an internal cavity extending from the inflow end to the outflow end. The die assembly also includes an internal mandrel disposed within the internal cavity. The internal mandrel has an end proximate to the outflow end of the die assembly. The internal mandrel is configured to form an interior hollow section in the extruded profile. The die assembly also includes an internal cooling channel within the internal mandrel. The internal cooling channel has an outlet disposed at or near the end of the internal mandrel. The system for cooling an extruded profile also includes a fluid source in communication with the internal cooling channel of the die assembly. The fluid source is configured to provide a flow of fluid through the internal cooling channel. The outlet of the internal cooling channel is configured to disperse the fluid into the interior hollow section of the extruded profile to cool the extruded profile.

In accordance with yet another aspect of the present disclosure, a die assembly includes an inflow end, an outflow end opposite the inflow end, and an internal cavity extending from the inflow end to the outflow end. The die assembly also includes an internal mandrel disposed within the internal cavity. The internal mandrel has an end proximate to the outflow end of the die assembly. The die assembly also includes an internal cooling channel within the internal mandrel. The internal cooling channel has an outlet at or near the end of the internal mandrel. The die assembly also includes a conduit fluidly coupled to the outlet and extending from the end of the internal mandrel. The conduit includes an opening.

In accordance with yet another aspect of the present disclosure, a system for cooling an extruded profile includes a die assembly. The die assembly includes an inflow end, an outflow end opposite the inflow end, and an internal cavity extending from the inflow end to the outflow end. The die assembly also includes an internal mandrel disposed within the internal cavity. The internal mandrel has an end proximate to the outflow end of the die assembly. The internal mandrel is configured to form an interior hollow section in the extruded profile. The die assembly also includes an internal cooling channel within the internal mandrel. The internal cooling channel has an outlet disposed at or near the end of the internal mandrel. The die assembly also includes a conduit fluidly coupled to the outlet and extending from the end of the internal mandrel. The conduit includes an opening. The system for cooling an extruded profile also includes an auxiliary conduit connected to an exterior surface of the die assembly. The auxiliary conduit extends in a direction of extrusion of the system. The auxiliary conduit is fluidly coupled to the internal cooling channel and includes an aperture. The system for cooling an extruded profile also includes a fluid source in communication with the internal cooling channel of the die assembly and the auxiliary conduit. The fluid source is configured to provide a flow of fluid through the internal cooling channel and the auxiliary conduit. The opening of the conduit is configured to disperse the fluid into the interior hollow section of the extruded profile to cool the extruded profile. The aperture of the auxiliary conduit is configured to disperse the fluid onto an exterior of the extruded profile to cool the extruded profile.

In connection with any of the aforementioned aspects, the devices, methods, and systems described herein may alternatively or additionally include any combination of one or more of the following features. The internal cooling channel includes another outlet disposed at the outflow end of the die assembly. The die assembly further includes a bridge connecting the internal mandrel to an interior surface of the die assembly, the internal surface of the die assembly being formed by the internal cavity. The internal cooling channel extends from an inlet disposed on an exterior surface of the die assembly to the outlet, such that the internal cooling channel extends through the die assembly, the bridge, and the internal mandrel. The inlet of the internal cooling channel is configured to receive a fluid into the internal cooling channel, the internal cooling channel is configured to allow the fluid to flow through the internal cooling channel within the die assembly, the bridge, and the internal mandrel to the outlet, and the outlet is configured to dispense the fluid out of the internal cooling channel to cool an interior channel of an extruded profile. The die assembly further includes an insulator lining an interior or the internal cooling channel. The die assembly includes two or more internal mandrels disposed within the internal cavity, the two or more internal mandrels being connected to an interior surface of the die assembly by one or more bridges, the interior surface of the die assembly being formed by the internal cavity. The die assembly further includes a temperature sensor channel extending into the die assembly from an opening on an exterior surface of the die assembly, the temperature sensor channel configured to accommodate a temperature sensor. The method further includes supplying the fluid through the internal cooling channel that extends through the die assembly, a bridge connecting the internal mandrel to an interior surface of the die assembly, the interior surface of the die assembly being formed by the internal cavity, and the internal mandrel. The fluid is dispersed uniformly into the interior hollow section of the extruded profile. The method further includes insulating the fluid within the internal cooling channel via an insulator lining an interior of the internal cooling channel. The fluid is conveyed by a plurality of internal cooling channels, each internal cooling channel of the plurality of internal cooling channels having an outlet disposed near or at the end of the internal mandrel, such that the fluid is conveyed to respective outlets of respective internal cooling channels. The fluid is dispersed at the respective outlets of the respective internal cooling channels into the interior hollow section of the extruded profile. The method further includes controlling a flow rate of the fluid within the internal cooling channel. The die assembly further includes a bridge connecting the internal mandrel to an interior surface of the die assembly, the interior surface of the die assembly being formed by the internal cavity. The die assembly further includes an inlet of the internal cooling channel located on an exterior surface of the die assembly, such that the internal cooling channel extends through the die assembly, the bridge, and the internal mandrel. The system further includes a thermocouple disposed in the die assembly. The system further includes a controller configured to control a rate of the flow of fluid from the fluid source. The system further includes a controller configured to control the dummy block within the extrusion chamber to force the billet of material through the die assembly. The controller is configured to control a rate at which the billet of material is forced through the die assembly. The opening is disposed at or near the distal end of the conduit. The opening is disposed along the length of the conduit. The opening includes a nozzle. An internal space of the conduit is converging or diverging. The opening is configured to control a flow rate and an angle at which a fluid impinges on a specific surface of an interior hollow section of an extruded profile. The conduit has a non-circular cross section. The internal cooling channel is configured to allow the fluid to flow through the internal cooling channel within the die assembly, the bridge, and the internal mandrel to the outlet and the conduit. The conduit is configured to allow the fluid to flow from the outlet through an internal space of the conduit and disperse the fluid out of the internal space to cool an interior hollow section of an extruded profile. The system further includes a quench box configured to cool an exterior surface of the extruded profile. The quench box is disposed downstream, in the direction of extrusion from the die assembly. The system further includes a straightening device configured to contact and straighten the extruded profile. The straightening device is disposed downstream, in the direction of extrusion, from the quench box. The straightening device comprises a dummy die. The dummy die includes an internal component configured to contact a surface of the interior hollow section of the extruded profile. The dummy die includes an external component configured to contact an exterior surface of the extruded profile. The straightening device comprises a clamp configured to grasp the extruded profile and pull the extruded profile in the direction of extrusion such that tension is applied to the extruded profile.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a perspective view of a die assembly in accordance with one example.

FIG. 2 illustrates a partial cutaway view of the die assembly of FIG. 1 in accordance with one example.

FIG. 3 illustrates a perspective view of a die assembly in accordance with one example.

FIG. 4 illustrates an exploded perspective view of a die assembly in accordance with one example.

FIG. 5 illustrates an exploded cross section view of the die assembly of FIG. 4 in accordance with one example.

FIG. 6 illustrates an exploded perspective view of a die assembly in accordance with one example.

FIG. 7 illustrates a cross section view of the die cap of FIG. 5 in accordance with one example.

FIG. 8 is a flow diagram of a method of cooling an extruded profile using a die assembly in accordance with one example.

FIG. 9 is a schematic view of a system for cooling an extruded profile in accordance with one example.

FIG. 10 is a schematic view of a system for cooling an extruded profile in accordance with one example.

FIG. 11 is a partial, perspective view of an extruded profile in accordance with one example.

FIG. 12 is a plan view of a cross section of an extruded profile in accordance with one example.

While the disclosed die assemblies, methods, and systems are susceptible of embodiments in various forms, there are illustrated in the drawings (and will hereafter be described) specific embodiments of the invention, with the understanding that the disclosure is intended to be illustrative and is not intended to limit the invention to the specific embodiments described and illustrated herein.

### DETAILED DESCRIPTION OF THE DISCLOSURE

As described above, the metal billet may be heated to various elevated temperatures before being extruded through a die. After passing through the die, heat treatable profiles are often cooled. Conventional cooling methods only directly cool an exterior of the extruded profile. For example, the outside of the extruded profile may be sprayed (i.e., quenched) with a fluid, such as water, to cool the extruded profile. One example of this is a quench curtain. However, this may cause the outside of the extruded profile to cool more quickly than the inside of the extruded profile. This is referred to as differential cooling, where different parts of the profile are cooled at different rates. When the extruded profile cools unevenly, geometric distortion (i.e., warping) and residual stresses (of trying to hold the geometry) occur in the extruded profile, which may lead to high (e.g., up to 50%) rejection rates of the extruded profile. The problems of distortion and residual stresses are exacerbated by complex profiles having multiple internal voids, particularly non-symmetric profiles. When traditional cooling methods are used, such as spraying the exterior surface of the extruded profile with a quench curtain, there may be a gap between the exit (i.e., outflow end) of the extrusion die and the entry of the quench curtain. Between billet pushes, there may be a length of the extruded profile that passes through the extrusion die but is not sprayed with a fluid because it does not reach the quench curtain. This length of the extruded profile may not be cooled quickly enough to retain certain material properties, and as a result this length of the extruded profile may have to be scrapped.

Die assemblies for cooling an extruded profile are described. Methods and systems for cooling an extruded profile using a die assembly are also described. The die assemblies, methods, and systems described herein may supply a flow of fluid to an interior hollow section formed in an extruded profile. The die assemblies, methods, and systems described herein may directly cool an interior hollow section(s) of an extruded profile and/or an exterior of the extruded profile.

The die assembly includes an inflow end, an outflow end opposite the inflow end, and an internal cavity extending between the inflow end and the outflow end. The die assembly includes an internal mandrel positioned within the internal cavity of the die assembly. The internal mandrel may be configured to form an interior hollow section in an extruded profile. The internal mandrel has an end near the outflow end of the die assembly and includes an internal cooling channel having an outlet located at or near the end of the internal mandrel, or located further away from the end of the internal mandrel when extensions or conduits are connected to the internal mandrel, as discussed below. The internal cooling channel may be configured to receive, convey, and disperse the flow of fluid through the outlet to cool the interior hollow section of the extruded profile. The flow of fluid dispersed at the outlet of the internal cooling channel into the interior hollow section of the extruded profile may be used to cool the extruded profile.

The die assembly may be configured to receive a billet of material at the inflow end. The die assembly may be configured to convey the billet material through the internal cavity and extrude the billet material as an extruded profile from the outflow end of the die assembly.

In some examples, the die assembly may include multiple internal mandrels. The extruded profile may include an interior hollow section for each internal mandrel in the die assembly. Accordingly, the die assemblies described herein may be used to manufacture complex extruded profiles having multiple interior hollow channels. In these examples, each of the internal mandrels may have respective internal cooling channels configured to receive, convey, and disperse the fluid through respective outlets to cool the interior hollow channels formed in the extruded profile by these multiple internal mandrels.

Complex extruded profiles having multiple interior hollow channels may be useful in a number of different applications. For example, the die assemblies, methods, and systems disclosed herein may be used to manufacture complex extruded profiles in automotive applications. For example, geometrically complex aluminum extrusion profiles may be used to make battery trays for electric vehicles. In order to reduce the weight of metal components for electric vehicles, for example, there is a need for stronger alloys and thinner wall sections. More complex shaped profiles with internal cavities, thinner walls, and stronger alloys lead to greater distortion problems as the profile is quenched as it exits the die. Cooling the extruded profile in a more uniform manner may help avoid these issues. Additionally, internal cooling of the extruded profile may ensure that peak age hardening is achieved. For example, internal cooling of the extruded profile may ensure that the extruded profile is quickly and uniformly cooled in order to maximize the benefits of a subsequent heat treatment process. Accordingly, internal cooling of the extruded profile allows for the highest potential alloy strength to be achieved. Obtaining a higher alloy strength may allow for further light weighting (e.g., reduction in the extruded profile size) and/or higher performance of the extruded profile.

The die assemblies, methods, and systems described herein may be used independently or in combination with other known or later developed devices, methods, and systems for cooling an extruded profile. For example, the die assemblies, methods, and systems described herein may be used in combination with a quench curtain that supplies a fluid to an exterior surface of the extruded profile to cool the exterior of the extruded profile.

The die assemblies, methods, and systems described herein are configured to supply a flow of fluid to an interior hollow section of an extruded profile to cool the extruded profile, and more specifically, to cool the interior of the extruded profile. A flow of fluid may be supplied to an interior hollow section of the extruded profile to cool the extruded profile more uniformly. More uniform cooling of the extruded profile may reduce or eliminate residual stresses and/or geometric distortion in the extruded profile. Specifically, internal cooling may eliminate poor mechanical properties (e.g., material strength) of the interior of complex multi-hollow aluminum profiles made from quench sensitive alloys. Additionally, more uniform cooling of the extruded profile may improve material strength in the extruded profile. Accordingly, the rejection rate of extruded profiles may be reduced, leading to less waste of material, energy, time, and labor and more efficient extrusion processes and systems.

Although described below in connection with metal extrusion, the disclosed die assembly devices, methods, and systems are also useful in various other applications. For example, the disclosed die assembly devices, methods, and systems may be used in connection with other materials, such as plastic extrusion and food processing extrusion (e.g., cooling and/or filling the interior of extruded foods).

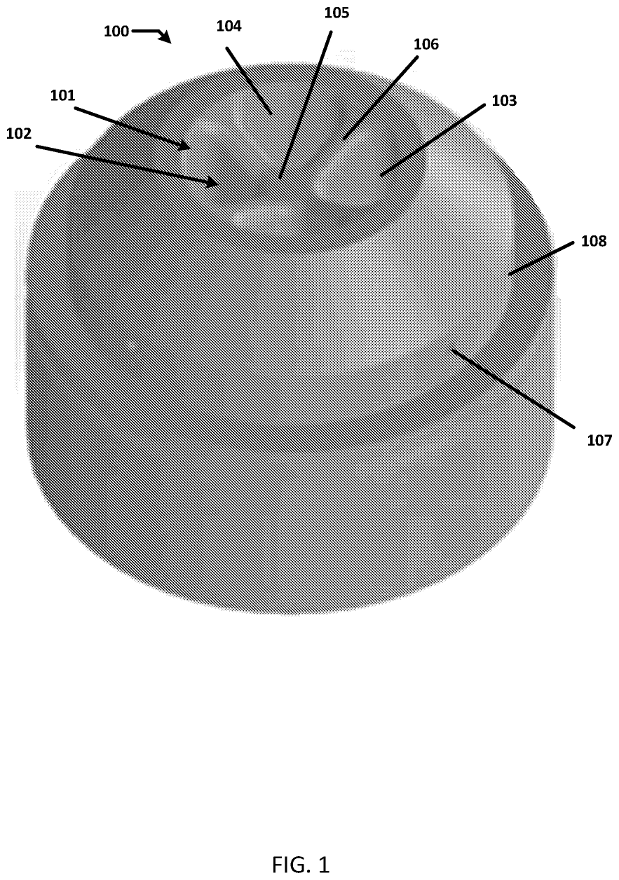

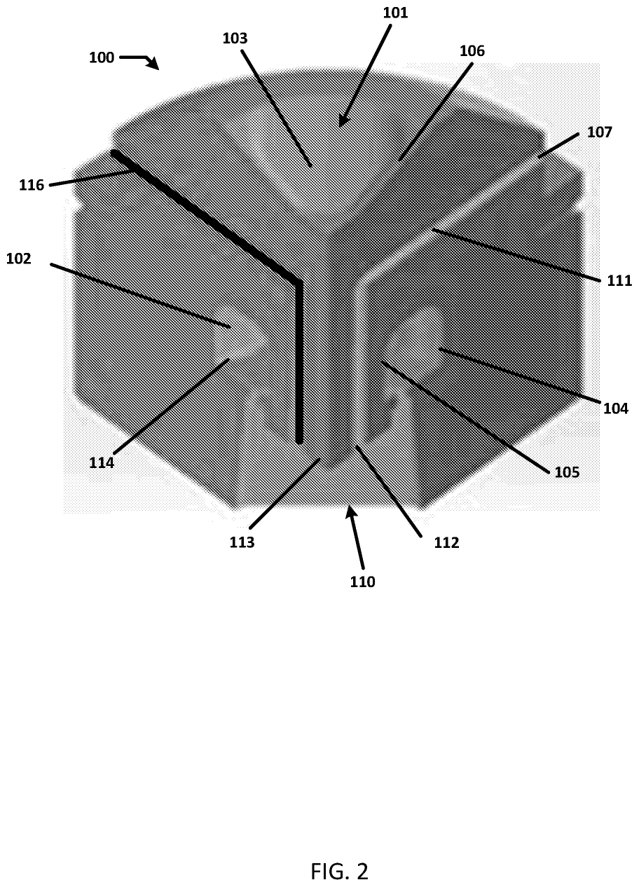

FIGS. 1 and 2 illustrate a die assembly 100 in accordance with one example of the present disclosure. FIG. 1 illustrates a perspective view of the die assembly 100. As shown in FIG. 1, the die assembly 100 includes an inflow end 101 and an internal cavity 102. The inflow end 101 of the die assembly 100 may be configured to receive a billet of material. The internal cavity 102 may be configured to convey the billet of material, received at the inflow end 101 through one or more portholes 103, through the die assembly 100. The internal cavity 102 forms an interior surface 104 of the die assembly 100. As shown in FIG. 1, the die assembly 100 also includes an internal mandrel 105 disposed centrally within the internal cavity 102 and connected or coupled to the interior surface 104 of the die assembly 100 via one or more bridges 106. In the example shown in FIG. 1, four bridges 106 connect the single internal mandrel 105 to the interior surface 104 of the die assembly 100. However, any number of bridges 106 and internal mandrels 105 may be used. The portholes 103 are the openings or inlets of the internal cavity 102 separated by the bridges 106. The location of the internal mandrel 105 within the internal cavity 102 may vary as well. For example, rather than being centrally located within the internal cavity 102, the internal mandrel 105 may be situated offset from the center and closely adjacent the interior surface 104. FIG. 1 also shows an inlet 107 of an internal cooling channel on an exterior surface 108 of the die assembly 100. As will be discussed below, the inlet 107 of the internal cooling channel may be located on other surfaces of the die assembly 100. While FIG. 1 illustrates an exterior view of a die assembly 100 in accordance with one example, the details of the inside of the various components of the die assembly 100 are discussed below with respect to the die assembly 100 shown in FIG. 2.

FIG. 2 depicts a partial cut-away view of a die assembly 100, such as the die assembly 100 of FIG. 1 discussed above. As shown in FIG. 2, the die assembly 100 includes an inflow end 101, an outflow end 110, an internal cavity 102 extending from the inflow end 101 to the outflow end 110, an internal mandrel 105, and an internal cooling channel 111. In some examples, the die assembly 100 may further include a bridge 106 connecting the internal mandrel 105 to the die assembly 100.

The inflow end 101 of the die assembly 100 may be configured to receive a block or billet of material (the “billet material”). The billet material may be a material from which an extruded profile is manufactured. In some examples, the billet material may be a metal. In some examples, the billet material may be aluminum or an aluminum alloy. For example, the billet material may be aluminum alloy AA6082. In other examples, the billet material may be a higher strength aluminum alloy, such as a 7000 series aluminum alloy (e.g., AA7005, AA7055, and the like). The billet material is not limited to the above-mentioned alloys or alloy ranges. It should be appreciated that an alloy belonging to any range of alloys may be used. In other examples, the billet material may be copper, steel, magnesium, lead, or any alloy thereof. In yet further examples, the billet material may be plastic or food product.

The billet material may be at an elevated temperature when it is received by the inflow end 101 of the die assembly 100. Receiving the billet material at an elevated temperature reduces the yield strength of the billet material and subsequently reduces the force required to feed the billet material through the die assembly 100. The temperature of the billet material when it is received by the inflow end 101 of the die assembly 100 may depend on the billet material used. For example, if the billet material is aluminum or an aluminum alloy, the billet material may be between 700° F. and 930° F. when it is received by the inflow end 101 of the die assembly 100. The billet material may be received by the inflow end 101 of the die assembly 100 at other temperatures as well. During the extrusion process, the plastic deformation of the material as it flows through the die may cause a further increase to the material temperature and cause it to transform into a single phase solid solution.

The outflow end 110 of the die assembly 100 is located opposite of the inflow end 101. The outflow end 110 of the die assembly 100 may be configured to extrude the billet material into the extruded profile. The outflow end 110 of the die assembly 100 may include an opening (e.g., an orifice) having a shape corresponding to a desired outer perimeter of the extruded profile. When the billet material reaches the outflow end 110 of the die assembly 100 it may be extruded (e.g., thrust, forced) through the opening in the outflow end 110 of the die assembly 100. Accordingly, while passing through the outflow end 110, the billet material may be forced into the shape of the opening in the outflow end 110 (e.g., a shape corresponding to a desired outer perimeter of the extruded profile). After passing through the outflow end 110, the billet material may become an extruded profile having an outer perimeter corresponding to the shape of the opening in outflow end 110 of the die assembly 100. The shape of the opening in the outflow end 110 may be variously modified to create extruded profiles having various shapes and sizes.

The internal cavity 102 of the die assembly 100 extends from the inflow end 101 of the die assembly 100 to the outflow end 110 of the die assembly 100. The internal cavity 102 may be configured to convey the billet material from the inflow end 101 of the die assembly 100 to the outflow end 110 of the die assembly 100. The die assembly 100 further includes an interior surface 104 formed by the internal cavity 102 of the die assembly 100. The interior surface 104 may extend around the internal cavity 102 from the inflow end 101 to the outflow end 110 of the die assembly 100. The internal cavity 102 may vary in size and shape and may or may not be uniform from the inflow end 101 to the outflow end 110.

Referring back to FIG. 2, the internal mandrel 105 is disposed within the internal cavity 102 and has an end 113 proximate to the outflow end 110 of the die assembly 100. The distance from the end 113 of the internal mandrel 105 to the outflow end 110 of the die assembly 100 may vary, such that a face of the end 113 of internal mandrel 105 and a face of the outflow end 110 of the die assembly 100 may be adjacent (i.e., the faces sharing a same plane or substantially close to sharing the same plane) or offset by a distance. In some examples, a face of the end 113 of the internal mandrel 105 may be disposed beyond a face of the outflow end 110 of the die assembly 100 (i.e., the internal mandrel 105 may extend beyond the internal cavity 102 formed in the die assembly 100). As shown in FIG. 2, the end 113 of the internal mandrel 105 is offset (internally within the internal cavity 102) from the outflow end 110 of the die assembly 100. The internal mandrel 105 may be configured to form an interior hollow section in an extruded profile. Specifically, as the billet material moves through the internal cavity 102 of the die assembly 100, the billet material may be forced to move around the internal mandrel 105. In other words, the internal mandrel 105 is held in place by the bridges 106 and over which the billet material flows to form the internal shape of the profile. As the billet material is extruded through the outflow end 110 of the die assembly 100, the billet material may be forced to flow both through the opening in the outflow end 110 and around the internal mandrel 105 of the die assembly 100. In some examples, the internal mandrel 105 may extend into the opening formed in the outflow end 110. As the billet material passes through the opening in the outflow end 110 of the die assembly 100, the billet material may move past (e.g., be extruded past) the end 113 of the internal mandrel 105 proximate to the outflow end 110 of the die assembly 100. As the billet material moves past the end 113 of the internal mandrel 105, an interior hollow section may be formed in the extruded profile. The internal mandrel 105 may form an interior hollow section in the extruded profile corresponding to the size and location of the internal mandrel 105. The size and location of the internal mandrel 105 may be variously modified to create interior hollow sections of various shapes and sizes within the extruded profile.

In some examples, the die assembly 100 may include two or more internal mandrels 105 disposed within the internal cavity 102. Each of the two or more internal mandrels 105 may create a respective interior hollow section in the extruded profile as the billet material is extruded through the outflow end 110 of the die assembly 100 and around each of the two or more internal mandrels 105. Multiple internal mandrels 105 may be used in order to create complex extruded profiles having multiple interior hollow sections.

The internal cooling channel 111 is formed within the internal mandrel(s) 105. The internal cooling channel 111 may be configured to convey a flow of fluid to an outlet 112 located at or near the end 113 of the internal mandrel 105. In one example, an outlet 112 located at the end 113 of the internal mandrel 105 may mean that the outlet 112 may be located on an end face of the internal mandrel 105. In another example, an outlet 112 located near the end 113 of the internal mandrel 105 may mean that the outlet 112 may be disposed on a side of the internal mandrel 105 adjacent to the end face of the internal mandrel 105. In one example, an outlet 112 located at or near the end of the mandrel means that the outlet 112 may be disposed on a surface of the internal mandrel 105 downstream (with respect to the flow of the billet material) of the welding chamber 114. In some examples, a plurality of internal cooling channels 111 may be formed within the internal mandrel 105. In these examples, each internal cooling channel 111 may have an outlet 112 disposed at the end 113 of the internal mandrel 105 (i.e., the end 113 of the internal mandrel 105 may include a plurality of outlets 112). The partial cut-away cross section shown in FIG. 2 illustrates two internal cooling channels 111. In some examples, the outlet 112, or each outlet 112, may include a nozzle. Various types of nozzles may be used. For example, flat fan nozzles, hollow cone nozzles, full cone nozzles, and the like may be used. In some examples, the outlets 112 may be configured to direct the flow of fluid such that the flow of fluid impacts a surface of the interior hollow section of the extruded profile formed by the internal mandrel 105 (i.e., an interior channel of the extruded profile). In one example, the outlet 112 may be configured to disperse, dispense, or discharge the fluid uniformly into the interior hollow section of the extruded profile. In another example, the outlet 112 may be configured to disperse the fluid non-uniformly into the interior hollow section of the extruded profile. In this case, the fluid may be discharged in a directional manner, directing the flow of fluid to a particular area or location of the interior hollow section of the extruded profile. For instance, the outlet 112 may be shaped to direct the flow of fluid towards a particular side of the interior hollow section, such as sides that require more cooling than others (e.g., due to different wall thickness or differing wall temperatures as the extruded profile exits the die assembly 100). Certain types of nozzles or fittings may be used for this purpose as well. In some examples, the outlet may control a flow rate of fluid dispersed, dispensed, or discharged by the outlet 112. In examples involving a plurality of internal cooling channels 111, and thus a plurality of outlets 112 formed in the internal mandrel 105, each of the outlets 112 may direct a flow of fluid toward a different surface of the interior hollow section of an extruded profile.

The location of the outlet 112 or outlets 112 at the end 113 of the internal mandrel 105 may vary. For instance, an outlet 112 of an internal cooling channel 111 may be located at any location on the face of the end 113 of the internal mandrel 105, such that an outlet 112 may be located along an edge of the face, at a central portion of the face, or any location there between. The placement of the outlet 112 or outlets 112 may depend upon the desired directional flow of the cooling fluid and/or whether the outlet 112 or outlets 112 are configured to discharge the fluid directionally or uniformly. In examples where the internal mandrel 105 extends beyond the internal cavity 102 of the die assembly 100, one or more outlets 112 may be disposed on an exterior surface 108 of the internal mandrel 105 other than the end 113 of the internal mandrel 105. In one example involving multiple cooling channels, two or more of the multiple cooling channels may merge within the internal mandrel 105 and form combined internal cooling channels 111. In this case, the number of internal cooling channel 111 outlets 112 may be smaller than the number of internal cooling channel 111 inlets 107. For example, a die assembly 100 having four bridges 106 connected to a single internal mandrel 105 may have four separate internal cooling channels 111 within each bridge 106, but the four internal cooling channels 111 may merge within the internal mandrel 105 and form a single combined internal cooling channel 111 within the internal mandrel 105. In this case, there is only a single outlet 112 disposed at the end 113 of the internal mandrel 105 even though there are four inlets 107 to the internal cooling channels 111 disposed on the exterior surface 108 of the die assembly 100. The reverse may also be true. For example, a single internal cooling channel 111 disposed within a single bridge 106 may split or divide into multiple internal cooling channels 111 within the internal mandrel 105, such that there is a single inlet 107 to the internal cooling channel 111 but multiple outlets 112. The number of inlets 107, outlets 112, and internal cooling channels 111 may depend on various factors, such as, for instance, the size of the die assembly 100, the size and/or shape of the internal cavity 102 of the die assembly 100, the number and/or geometry of bridges 106, the number and/or geometry of internal mandrels 105, the size of desired inlets 107 and/or outlets 112, the billet material being extruded, the cooling fluid, the desired extruded profile, and the like.

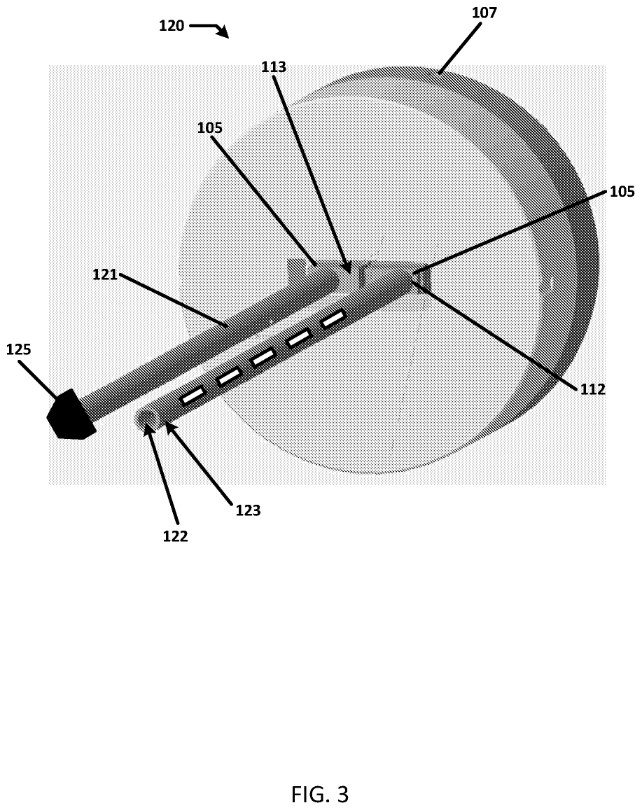

In some examples, the die assembly may further include one or more extensions or conduits fluidly coupled to the outlet(s) 112. FIG. 3 illustrates a die assembly 120 including two internal mandrels 105 and a conduit 121 extending from the end 113 of each internal mandrel 105. The die assembly 120 and some of its respective components may be the same as those discussed above with respect to the die assembly 100 of FIGS. 1 and 2. For example, the inflow end 101, outflow end 110, internal cavity 102, interior surface 104, bridge 106, the internal mandrel 105, exterior surface 108, and outlet 112 may be the same as those discussed above with respect to the die assembly 100 of FIGS. 1 and 2. However, the die assembly 120 includes two internal mandrels 105 each of which will create an interior hollow section in the extruded profile as the billet material is extruded through the outflow end 110 of the die assembly 120. The die assembly 120 of FIG. 3 also includes two conduits 121, each fluidly coupled to an outlet 112 disposed on an end 113 of a respective internal mandrel 105.

Each conduit 121 may be fluidly coupled to an outlet 112 disposed on the end 113 of an internal mandrel 105 and extend away or protrude from the end 113 of the internal mandrel 105. Each conduit 121 may extend away from the end 113 of the internal mandrel 105 in the direction in which billet material is extruded through the die assembly 120. A distance away from the internal mandrel that the conduit 121 extends may vary. For example, a distal end 123 of the conduit 121 may be more than half a meter from the end 113 of the internal mandrel 105, more than a meter from the end 113 of the internal mandrel 105, or more than one and a half meters from the end 113 of the internal mandrel 105. In some examples, a distal end 123 of the conduit 121 may be located between a half meter and two meters away from the end 113 of the internal mandrel 105. In some examples, a distal end 123 of the conduit 121 may be less than five meters from the end 113 of the internal mandrel 105. In some examples, a distal end 123 of the conduit 121 may be less than half a meter from the end 113 of the internal mandrel 105.

Each conduit 121 may be attached or coupled to an outlet 112. In some examples, a threaded connection may be used to connect or couple the outlet 112 and the conduit 121. In other examples, the conduit 121 may be welded to the outlet 112. In some examples, the conduit 121 may be attached or coupled (e.g., welded) to an end 113 of the internal mandrel 105. In other embodiments, the conduit 121 may be bolted to an end 113 of the internal mandrel 105 using a flange. In some examples, two or more conduits 121 may extend away from the end 113 of a single internal mandrel 105. For example, two outlets 112 may be disposed at the end 113 of a single internal mandrel 105 and a conduit 121 may be attached or coupled to each outlet 112.

The conduit 121 includes an internal space, channel or pathway through which fluid may flow through the conduit 121. The conduit 121 may be configured to convey or allow a flow of fluid from the outlet 112 of the internal cooling channel 111 to an opening 122 in the conduit 121. The opening 122 in the conduit 121 may be configured to disperse, dispense, or discharge fluid into an interior hollow section of the extruded profile. In some examples, the opening 122 may be disposed at a distal end 123 of the conduit 121 opposite the internal mandrel 105. In other examples, the opening 122 may be disposed along the length of the conduit 121 (i.e., either a discreet opening 122 at a single location along the length of the conduit 121 or a long opening 122 continuously open along a certain length of the conduit 121). In some examples, the conduit 121 may include more than one opening 122. For example, the conduit 121 may include an opening 122 disposed at a distal end 123 of the conduit 121 and one or more openings 122 disposed along the length of the conduit 121, as illustrated in FIG. 3. In some examples, the conduit 121 may include multiple openings 122 disposed radially around the conduit 121. In some examples, the opening 122 may be disposed downstream of the outflow end 110 of the die assembly 120.

In some examples, the opening 122, or each opening 122, may include a nozzle 125. In some examples, one or more openings 122 disposed along the length of the conduit 121 may include a nozzle 125. Various types of nozzles may be used. For example, flat fan nozzles, hollow cone nozzles, full cone nozzles, and the like may be used. In some examples, the opening may control a flow rate of fluid dispersed, dispensed, or discharged from the opening 122. In some examples, the openings 122 may be configured to direct the flow of fluid such that the flow of fluid impacts a surface of the interior hollow section of the extruded profile formed by the internal mandrel 105 (i.e., an interior channel of the extruded profile). In one example, the opening 122 may be configured to disperse, dispense, or discharge the fluid uniformly into the interior hollow section of the extruded profile. In another example, the opening 122 may be configured to disperse the fluid non-uniformly into the interior hollow section of the extruded profile. In this case, the fluid may be discharged in a directional manner, directing the flow of fluid to a particular area or location of the interior hollow section of the extruded profile. For instance, the opening 122 may be shaped to direct the flow of fluid towards a particular side of the interior hollow section. Certain types of nozzles or fittings may be used for this purpose as well. In examples involving a plurality of openings 122, each of the openings 122 may direct a flow of fluid toward a different surface of the interior hollow section of an extruded profile.

The conduit 121 may allow fluid to be dispersed downstream, i.e., in the direction of extrusion, of the outflow end 110 of the die assembly 120. In some examples, the internal space, channel, or pathway in the conduit 121 may be converging or diverging to manage fluid pressure as desired. In other examples, the internal space, channel, or pathway in the conduit may be the same size along the length of the conduit 121. Accordingly, a location at which fluid is dispersed to an interior hollow section of the extruded profile may be controlled to be downstream of the outflow end 110 of the die assembly 120. In some examples, the location at which fluid is dispersed into the interior hollow section of the profile may be advantageously selected so as to be the same location at which fluid is dispersed to an exterior of the extruded profile to provide more uniform cooling of the extruded profile, thereby minimizing deformation and improving material strength in the extruded profile.

In some examples, as illustrated in FIG. 3, the conduit 121 may have a hollow cylindrical shape. However, the shape of the conduit 121 is not limited thereto. For example, the conduit 121 may have a hollow rectangular shape, or any other shape suitable to convey a flow of fluid. The conduit 121 may be comprised of a metal or a metal alloy. In some examples, the conduit 121 may be comprised of a steel alloy. For example, the conduit 121 may be comprised of stainless steel. In some examples, the conduit 121 may be comprised of H-13 steel alloy. In some examples, the conduit 121 may be heat treated. In other examples, the conduit 121 may be comprised of another material, such as a ceramic, plastic, or another suitable material.

The fluid may be configured to cool the extruded profile. The fluid may be one of water (i.e., H₂O), Nitrogen (i.e., N₂), Oxygen (O₂), Carbon Dioxide (CO₂) and the like, and any mixture thereof. Other fluids are possible. In some examples, the internal cooling channel 111 may further include an insulator 116 lining an interior of the internal cooling channel 111 (i.e., an insulating coating applied directly to the inside of the internal cooling channel 111 walls). The insulator 116 may insulate the fluid flowing through the internal cooling channel 111 from the various components of the die assembly 100 in which the internal cooling channel 111 is located. The insulator 116 lining may prevent excessive heating of the fluid as it travels through or traverses the die assembly 100. Additionally, the insulator 116 may prevent excessive cooling of the die assembly 100. As described below, an insulating tube or hose may also be used to achieve these purposes as well.

In addition to conveying the fluid to the outlet 112 to cool an interior channel of an extruded profile, the internal cooling channel 111 and the fluid conveyed therein may be used to cool the die assembly 100 and components thereof. The internal cooling channel 111 may be configured to cool any portion of the die assembly 100 in which the internal cooling channel 111 is formed. For example, the internal cooling channel 111 may be configured to cool the internal mandrel 105 as the fluid flows through a portion of the internal cooling channel 111 located in the internal mandrel 105. The internal cooling channel 111 may also allow bridges 106, as described below, to be cooled. The internal cooling channels 111 in the die assembly 100 may also help prevent an overheating of the work piece material (billet) inside the die assembly 100, which would increase the productivity of extrusion processes, such as aluminum extrusion.

In some examples, the die assembly 100 may include a bridge 106. The bridge 106 may connect the internal mandrel 105 to an interior surface 104 of the die assembly 100. As discussed above, the interior surface 104 of the die assembly 100 may be formed by the internal cavity 102. The bridge 106 may be disposed in the internal cavity 102 of the die assembly 100. In some examples, only a single bridge 106 may connect the internal mandrel 105 to the interior surface 104 of the die assembly 100. In other examples, two or more bridges 106 may connect the internal mandrel 105 to the interior surface 104 of the die assembly 100. As shown in FIG. 1, there are four bridges 106 connecting the internal mandrel 105 to the interior surface 104 of the die assembly 100. The partial cut-away cross section shown in FIG. 2 illustrates two bridges 106. In some examples, a portion of the internal cooling channel 111 may be formed in the bridge 106. In some examples, a single cooling channel may be formed in the bridge 106. In other examples, multiple cooling channels may be formed in the bridge 106. In the example shown in FIG. 2, each bridge 106 has a single internal cooling channel 111.

In examples including a bridge 106, as the billet material moves through the internal cavity 102 of the die assembly 100, the billet material may move around and over the one or more bridges 106. In some examples, the billet material may move through one or more portholes 103. The portholes 103 may be openings in, or inlets of, the internal cavity 102 of the die assembly 100 formed by two or more bridges 106 disposed in the internal cavity 102. In other words, the portholes 103 are the openings or inlets of the internal cavity 102 separated by the bridges 106. FIG. 1 illustrates four portholes 103. In some examples, as shown in FIG. 2, the internal cavity 102 includes a welding chamber 114 where the billet material is combined after flowing through different portholes 103 and around the bridges 106 in the die assembly 100. The welding chamber 114 may provide sufficient volume for the portions of billet material flowing through different portholes 103 and around the bridges 106 to weld before flowing around the internal mandrel 105 and through the outflow end 110 of the die assembly 100.

The internal cooling channel 111 may have an inlet 107 located on an exterior surface 108 of the die assembly 100. Accordingly, in these examples, the internal cooling channel 111 may extend from an inlet 107 disposed on the exterior surface 108 of the die assembly 100, through the die assembly 100, through the bridge 106, and through the internal mandrel 105 to the outlet 112 disposed at the end 113 of the internal mandrel 105. The inlet 107 of the internal cooling channel 111 may be configured to receive a fluid into the internal cooling channel 111. The internal cooling channel 111 may be configured to allow the fluid to flow through the internal cooling channel 111 within the die assembly 100, the bridge 106, and the internal mandrel 105 to the outlet 112. The outlet 112 may be configured to disperse the fluid out of the internal cooling channel 111 to cool an interior of the extruded profile.

In some examples, the die assembly 100 may further include a temperature sensor channel extending into the die assembly 100 from an opening on an exterior surface 108 of the die assembly 100. The temperature sensor channel may be configured to accommodate a temperature sensor. The temperature sensor channel may be configured so that a sensing end of the temperature sensor is within or adjacent to one of the various components of the die assembly 100. For example, the temperature sensor channel may be configured so that a sensing end of the temperature sensor is within or adjacent to the die assembly 100, the internal mandrel 105, or the bridge 106. In some examples, two or more temperature sensor channels may be formed in the die assembly 100. In some examples, the temperature sensor may be a thermocouple.

The die assembly 100 may include a steel alloy. For example, the die assembly 100 may include H-13 steel alloy. The die assembly 100 may be heat treated. In some examples, the die assembly 100 as described herein may be formed using 3D printing (e.g., direct metal laser sintering, direct laser metal melting, etc.). In other examples, the die assembly 100 may be formed by drilling the internal cooling channel 111 from the inlet 107 and/or the outlet 112. In yet other examples, the die assembly 100 may be formed of two parts on either side of a plane including the internal cooling channel 111, and the internal cooling channel 111 may be machined in each part before joining the two parts of the die assembly 100. Any insulator 116 or hose 145 may be inserted into the cooling channel before joining the two parts of the die assembly 100. In some examples, the die assembly 100 as described herein may include two or more components containing the constituent elements of the die assembly 100 described above. In other examples, the die assembly 100 and the components thereof as described herein may be integrally formed as one unit (i.e., monolithic).

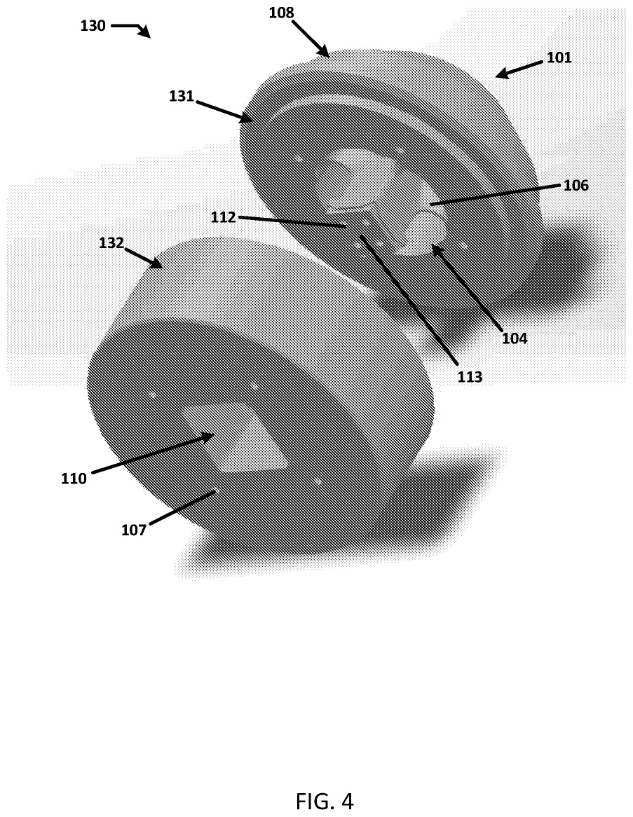

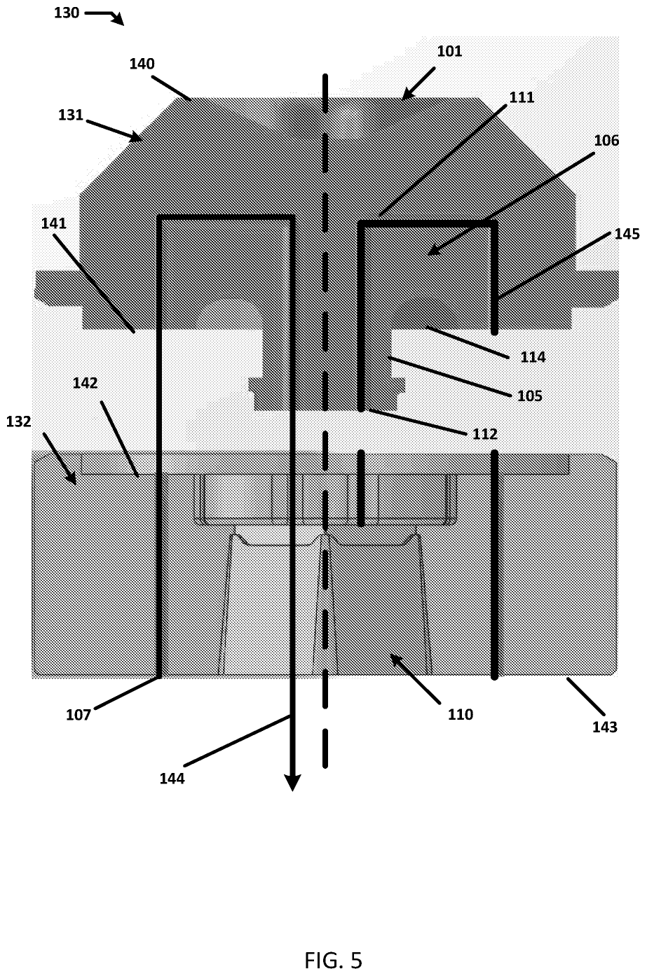

In some examples, the die assembly 100 described above may consist of two pieces or portions (i.e., subparts of the die assembly 100) that are configured to abut one another, mate or otherwise couple together. The first piece is the die mandrel 131, which includes the bridges 106 and forms the internal geometry of the extruded profile. The second piece is the die cap 132, which is downstream (with respect to the flow of billet material) from the die mandrel 131 and forms the exterior geometry of the extruded profile. FIGS. 4 and 5 illustrate an example of a two-piece die assembly 130 being composed of a die mandrel 131 and a die cap 132. FIG. 4 illustrates an exploded perspective view of the die assembly 130 and FIG. 5 illustrates an exploded cross section view of the die assembly 130 of FIG. 4. Various components of the die assembly 130 as illustrated in FIGS. 4 and 5 may be the same as those discussed above with respect to FIGS. 1 and 2. For example, the inflow end 101, outflow end 110, internal cavity 102, and the internal mandrel 105 as illustrated in FIGS. 4 and 5 may be the same as those described above with respect to FIGS. 1 and 2. Further, the interior surface 104, outlet 112, bridge 106, and exterior surface 108 as illustrated in FIGS. 4 and 5 may be the same as those described above with respect to FIGS. 1 and 2. However, the internal cooling channel 111, and the inlet 107 thereof, of FIGS. 4 and 5 vary slightly from that of FIGS. 1 and 2. As shown in FIGS. 4 and 5, rather than being disposed on the exterior surface 108 proximate the inflow end 101 of the die assembly 100, the inlet 107 of the internal cooling channel 111 is disposed on the exterior surface at the outflow end 110 of the die assembly 100.

As shown in FIGS. 4 and 5, the die mandrel 131 may have a first surface 140 corresponding to the inflow end 101 of the die assembly 130 and a second surface 141 opposite the first surface 140. The die mandrel 131 may include the inflow end 101 of the die assembly 130, a first (i.e., upper or upstream) portion of the internal cavity 102 extending from the inflow end 101 of the die assembly 130 to the second surface 141 of the die mandrel 131, the internal mandrel 105, and a portion of the internal cooling channel 111 extending from the second surface 141 of the die mandrel 131 to the outlet 112 disposed at the end 113 of the internal mandrel 105. In some examples, the die mandrel 131 may include the entire internal cooling channel 111 extending from an inlet 107 located on the exterior surface 108 of the die mandrel 131 to an outlet 112 located on the internal mandrel 105. In some examples, the die mandrel 131 may further include one or more bridges 106 connecting the internal mandrel 105 to the interior surface 104 of the die mandrel 131 and one or more portholes 103 located in the internal cavity 102 and extending around the one or more bridges 106. The second surface 141 of the die mandrel 131 may be configured to be received by or coupled to the die cap 132.

The die cap 132 may have a first surface 142 configured to receive, mate, or be coupled to the second surface 141 of the die mandrel 131. The die cap 132 may also have a second surface 143 opposite the first surface 142, the second surface 143 of the die cap 132 corresponding to the outflow end 110 of the die assembly 130. The die cap 132 may include a second (i.e., lower or downstream) portion of the internal cavity 102 extending from the first surface 142 of the die cap 132 to the outflow end 110 of the die assembly 130. The die cap 132 may further include a portion of the internal cooling channel 111 extending from an inlet 107 located on the second surface 143 of the die cap 132 to the first surface 142 of the die cap 132.

The die mandrel 131 and the die cap 132 may be configured to mate or couple to one another to form the die assembly 130. The second surface 141 of the die mandrel 131 and the first surface 142 of the die cap 132 may be configured to abut one another when the die mandrel 131 and die cap 132 are mated or coupled together. The internal mandrel 105 of the die mandrel 131 may extend beyond the second surface 141 of the die mandrel 131 and into the second portion of the internal cavity 102 formed in the die cap 132 when the die mandrel 131 and the die cap 132 are mated or coupled together. When the die mandrel 131 and the die cap 132 are mated or coupled together to form the die assembly 130, the inflow end 101 located on the die mandrel 131 and the outflow end 110 located on the die cap 132 are fluidly coupled to one another (i.e., in fluid communication with one another). Accordingly, an internal cavity 102 may be formed that extends from the inflow end 101, through the die mandrel 131 and around the bridges 106 to form portholes 103, into the welding chamber 114, through the die cap 132 and around the internal mandrel 105 to the outflow end 110 of the die cap 132.

FIG. 5 illustrates an exploded cross section view of the die assembly 130 of FIG. 4 in accordance with one example. FIG. 5 illustrates an interior cooling flow path 144 through which fluid may be conveyed to cool an interior hollow section of an extruded profile. In some examples, when the die assembly 130 comprises a die mandrel 131 and a die cap 132, the internal cooling channel 111 may extend through both the die mandrel 131 and the die cap 132. In some examples, the internal cooling channel 111 may extend through the die cap 132 from an inlet 107 located on the second surface 143 of the die cap 132 to the first surface 142 of the die cap 132. The internal cooling channel 111 may extend through the die mandrel 131 from the second surface 141 of the die mandrel 131 to an outlet 112 located on the end 113 of the internal mandrel 105. When the die cap 132 and the die mandrel 131 are coupled together, the portion of the internal cooling channel 111 formed in the die cap 132 and the portion of the internal cooling channel 111 formed in the die mandrel 131 are in fluid communication with (i.e., fluidly coupled to) one another.

In some examples, a hose 145 may be provided within the internal cooling channel 111. A single or unitary length of hose 145 may extend through the portion of the internal cooling channel 111 formed in the die cap 132 and the portion of the internal cooling channel 111 formed in the die mandrel 131. In this way, the fluid (e.g., coolant) supplied through the internal cooling channel 111 may be provided through the hose 145. In some examples, the hose 145 may facilitate the transfer of fluid from the die cap 132 to the die mandrel 131 (i.e., help the fluid to traverse the interface between the first surface 142 of the die cap 132 and the second surface 141 of the die mandrel 131). In some examples, the hose 145 may be disposed within the internal cooling channel 111 such that an air gap exists between the hose 145 and the wall of the internal cooling channel 111. The air gap may be provided to reduce heat transfer between the die assembly 130 and the fluid conveyed through the hose 145 in the internal cooling channel 111. In some examples, an interior of the internal cooling channel 111 may include an insulator (e.g., 116) disposed between the hose 145 and the internal cooling channel 111. In some examples, an exterior of the hose 145 may be comprised of an insulating material to prevent excessive heating of the fluid and/or excessive cooling of the die assembly 130.

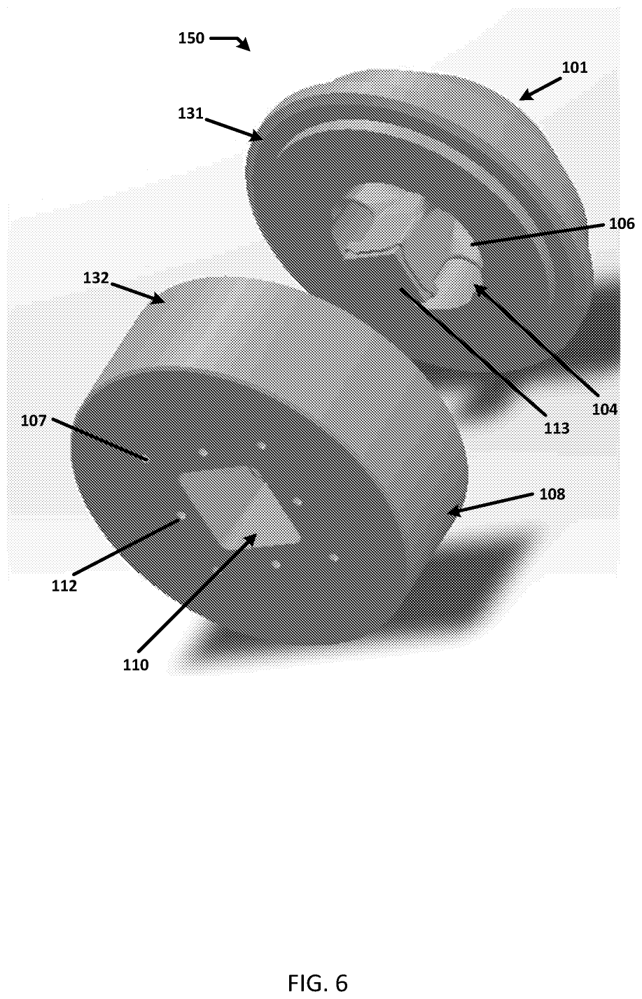

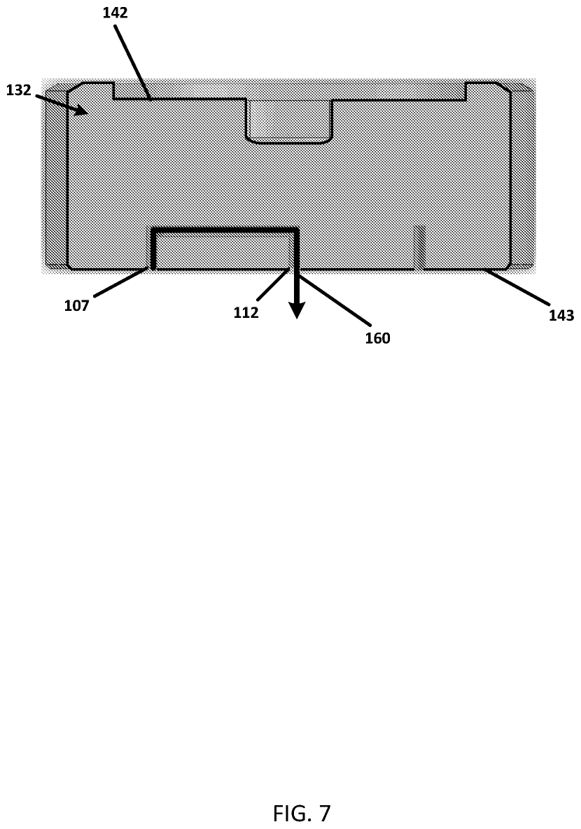

Die assemblies containing conformal cooling channels 111 may also be used to perform exterior quenching of the extruded profiles very close to the outflow end 110 (i.e., die exit). This may help relieve distortion problems and also the quench curtain scrap problem that comes from failing to quench the last part of the extruded billet, as discussed above. FIGS. 6 and 7 illustrate a die assembly 150 in accordance with one such example. FIG. 6 illustrates an exploded perspective view of the die assembly 150. The die assembly 150 may include a die mandrel 131 and a die cap 132. The die mandrel 131 and the die cap 132 and some of their respective constituent components may be the same as those discussed above with respect to the die assembly 130 of FIGS. 4 and 5. For example, the inflow end 101, out flow end, internal cavity 102, interior surface 104, bridge 106, the internal mandrel 105, exterior surface 108, first and second surfaces 140 and 141 of the die mandrel 131 and first and second surfaces 142 and 143 of the die cap 132 may be the same as those discussed above with respect to the die assembly 130 of FIGS. 4 and 5.

As illustrated in FIGS. 6 and 7, the internal cooling channel 111 may be disposed entirely within the die cap 132. The internal cooling channel 111 may have one or more inlets 107 located on the second surface 143 of the die cap 132 and one or more outlets 112 also disposed on the second surface 143 of the die cap 132. The outlets 112 may be more proximate to the opening formed in the outflow end 110 (i.e., second surface 143 of the die cap 132) than the inlets 107. The outlets 112 may be the same as those described above with respect to the die assembly 100 of FIG. 2, except for their location on the die assembly 150. For example, the outlets 112 may include nozzles and/or be configured to direct fluid toward a surface of the extruded profile. In some examples, the inlet 107 for the internal cooling channel 111 may be disposed at a different location on the die assembly 150. In one example, the inlet 107 may be located on an exterior surface 108 of the die mandrel 131 and a portion of the internal cooling channel 111 may be formed in the die mandrel 131.

FIG. 7 illustrates a cross section view of the die cap 132 of FIG. 6 in accordance with one example. As shown in FIG. 7, an exterior cooling flow path 160 may be formed in the die cap 132. An internal cooling channel 111, and accordingly an exterior cooling flow path 160, may extend from an inlet 107 located on the second surface 143 of the die cap 132 through a portion of the die cap 132 and to an outlet 112 also disposed on the second surface 143 of the die cap 132. In this example, the interior cooling channel 111 may be configured to convey the fluid to the outlet 112 such that the fluid cools an exterior surface of the extruded profile. The internal cooling channel 111 may further include a hose 145 as described above with respect to the die assembly 130 of FIGS. 4 and 5. In addition to conveying the fluid to the outlet 112 disposed on the second surface 143 of the die cap 132, the fluid traveling through the internal cooling channel 111 may also cool the die cap 132. The internal cooling channels 111 and outlets 112 located on the second surface 143 of the die cap 132 may cool an exterior surface of an extruded profile as the extruded profile flows out of the outflow end 110 of the die assembly 150. Accordingly, in addition to minimizing distortion, a length of extruded profile that passes through the die assembly 150 but that does not reach a separate, spaced apart quench curtain between billet pushes that is typically scrapped may be preserved.

In some examples, a die assembly may include one or more internal cooling channels 111 as described above with respect to the die assembly 130 of FIGS. 4 and 5 and one or more internal cooling channels 111 as described above with respect to the die assembly 150 of FIGS. 6 and 7. Accordingly, a die assembly 130, 150 may include internal cooling channels 111 and respective outlets 112 configured to provide a fluid to both a surface of the interior hollow section of the extruded profile (e.g., outlet(s) 112 disposed on the end 113 of the internal mandrel 105) and an exterior surface of the extruded profile (e.g., outlet(s) 112 disposed on the second surface 143 of the die cap 132) allowing both a surface of an interior hollow section of an extruded profile and an exterior surface of the extruded profile to be cooled. In some embodiments, an internal cooling channel 111 with an outlet 112 disposed on the end 113 of the internal mandrel 105 and an internal cooling channel 111 with an outlet 112 disposed on the second surface 143 of the die cap 132 may each have their own respective inlets 107 located on the die assembly 130, 150. In other embodiments, an internal cooling channel 111 with an outlet 112 disposed on the end 113 of the internal mandrel 105 and an internal cooling channel 111 with an outlet 112 disposed on the second surface 143 of the die cap 132 may be connected to one another and share the same inlet 107. Accordingly, a fluid may be supplied through the inlet 107 and the internal cooling channel 111 may split, where a portion of the internal cooling channel 111 leads the fluid to one outlet 112 disposed on the end 113 of the internal mandrel 105 and where another portion of the internal cooling channel 111 leads the fluid to another outlet 112 disposed on the second surface 143 of the die cap 132.

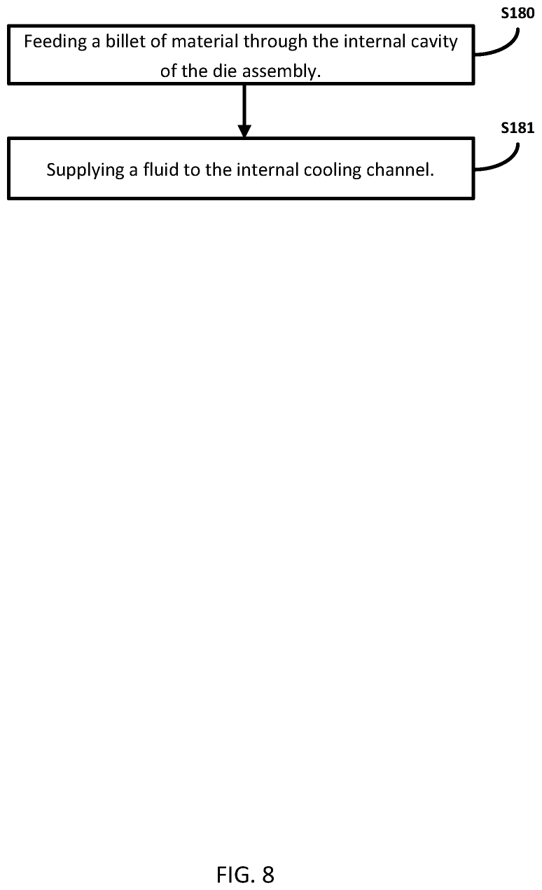

FIG. 8 illustrates a flow chart depicting a method of cooling an extruded profile with a die assembly in accordance with one example. The method of FIG. 8 may be implemented using any of the die assemblies 100, 120, 130, and 150 described above. For example, the method of cooling an extruded profile may be used with a die assembly 100 having an inflow end 101, an outflow end 110 opposite the inflow end 101, an internal cavity 102 extending from the inflow end 101 to the outflow end 110, an internal mandrel 105 disposed within the internal cavity 102, the internal mandrel 105 having an end proximate to the outflow end 110 of the die assembly 100, and an internal cooling channel 111 within the internal mandrel 105, the internal cooling channel 111 extending from an inlet 107 disposed on an exterior surface 108 of the die assembly 100 to an outlet 112 disposed on the end 113 of the internal mandrel 105. In other examples, a different die assembly 100 may be used. The method may be implemented in the order shown but may be implemented in or according to any number of different orders. Additional, different, or fewer acts may be provided.

The method of cooling an extruded profile with a die assembly 100 may include feeding a billet of material through the internal cavity 102 of the die assembly 100 (S180), such that the billet of material is extruded through the outflow end 110 of the die assembly 100 to form the extruded profile, the extruded profile having an interior hollow section formed by the internal mandrel 105. The billet material may be the same as discussed above with respect to the die assembly 100 of FIGS. 1 and 2. The inflow end 101 of the die assembly 100 may receive the billet material. The billet material may pass through the inflow end 101, through the portholes 103 and around the bridges 106 into the welding chamber 114. A dummy block may feed (e.g., force, push) the billet material through the internal cavity 102 of the die assembly 100. In some examples, the billet material may be at an elevated temperature as it is fed through the internal cavity 102 of the die assembly 100.

The method of cooling an extruded profile with a die assembly 100 may also include supplying a fluid to the internal cooling channel 111 (S181). The internal cooling channel 111 may be configured to convey the fluid from the inlet 107 to the outlet 112 of the internal cooling channel 111, such that the fluid is dispersed at the outlet 112 of the internal cooling channel 111 within the internal mandrel 105 into the interior hollow section on the extruded profile to cool the extruded profile. In some examples the supplying the fluid may include supplying the fluid through the internal cooling channel 111 that extends through the die assembly 100, a bridge 106 connecting the internal mandrel 105 to an interior surface 104 of the die assembly 100, the interior surface 104 of the die assembly 100 being formed by the internal cavity 102, and the internal mandrel 105. In some examples, the fluid may be dispersed uniformly into the interior hollow section of the extruded profile. In other examples, the fluid may be dispersed non-uniformly into the interior hollow section of the extruded profile. In some examples, the fluid may be conveyed by a plurality of internal cooling channels 111. In this case, each of the internal cooling channels 111 of the plurality of internal cooling channels 111 may have an outlet 112 disposed on the end 113 of the internal mandrel 105 such that the fluid is conveyed to respective outlets 112 of respective internal cooling channels 111. In some examples, the fluid may be dispersed at respective outlets 112 of respective internal cooling channels 111 into the interior hollow section of the extrude profile.

In some examples, the method of cooling an extruded profile with a die assembly 100 may further include conveying, by the internal cooling channel 111, a fluid from the inlet 107 to the outlet 112 of the internal cooling channel 111. The fluid may be the same as discussed above with respect to the die assembly 100 of FIGS. 1 and 2. In some examples, the conveying may include transporting the fluid through the internal cooling channel 111 that extends through the internal mandrel 105. In some examples, as discussed above, the die assembly 100 may further include one or more bridges 106 connecting the internal mandrel 105 to an interior surface 104 of the die assembly 100 and the internal cooling channel 111 may further include an inlet 107 located on the exterior surface 108 of the die assembly 100. In these examples, the conveying may include receiving, by the inlet 107 of the internal cooling channel 111, the fluid from a fluid source and transporting the fluid through the internal cooling channel 111 that extends through the die assembly 100, a bridge 106 connecting the internal mandrel 105 to an interior surface 104 of the die assembly 100, the interior surface 104 of the die assembly 100 being formed by the internal cavity 102, and the internal mandrel 105.

In some examples, the method of cooling an extruded profile with a die assembly 100 may further include extruding the billet material through the outflow end 110 of the die assembly 100 to form the extruded profile, the extruded profile having an interior hollow section formed by the internal mandrel 105. The dummy block may be used to extrude (e.g., force, push) the billet material through the opening in the outflow end 110 of the die assembly 100. The outflow end 110 of the die assembly 100 may have a shape that corresponds to a desired exterior surface of the extruded profile. As the billet material moves through the opening in the outflow end 110 of the die assembly 100, it moves around the internal mandrel 105 of the die assembly 100 forming a hollow interior channel or interior hollow section in the extruded profile. The billet material may be at an elevated temperature during the extruding of the billet material through the outflow end 110 of the die assembly

In some examples, the method of cooling an extruded profile with a die assembly 100 may further include dispersing the fluid at an outlet 112 of the internal cooling channel 111 within the internal mandrel 105 into the interior hollow section of the extruded profile to cool the extruded profile. In one example, the dispersing may include dispersing the fluid uniformly into the interior hollow section of the extruded profile. In some examples, the dispersing the fluid at an outlet 112 of the cooling channel 111 within the internal mandrel 105 may include directing the fluid to impinge on one or more surfaces of the interior hollow section of the extruded profile. In some examples, the dispersing the fluid at an outlet 112 of the internal cooling channel 111 may further include dispersing the fluid through one or more nozzles located at the outlet 112. In some examples, the dispersing the fluid at the outlet 112 of the internal cooling channel 111 may occur at the same time as the extruding the billet material at the outflow end 110 of the die assembly 100.

In some examples, the internal mandrel 105 may include a plurality of internal cooling channels 111, each internal cooling channel 111 of the plurality of internal cooling channels 111 having an outlet 112 disposed at the end 113 of the internal mandrel 105. In these examples, the conveying may include conveying, by the plurality of internal cooling channels 111, the fluid to respective outlets 112 of the respective internal cooling channels 111. In these examples, the dispersing may include dispersing the fluid at the respective outlets 112 of the respective internal cooling channels 111 into the interior hollow section of the extruded profile.

In some examples, the method of cooling an extruded profile with a die assembly 100 may further include insulating the fluid within the internal cooling channels 111 via an insulator 116 lining an interior of the internal cooling channel 111. The insulator lining 116 may be the same as described above with respect to the die assembly 100 of FIGS. 1 and 2. The fluid within the internal cooling channels 111 may be insulated to prevent excessive heating of the fluid as the fluid is conveyed from the inlet 107 to the outlet 112 of the cooling channel. In other examples, a hose may be fed through the internal cooling channels 111 to supply the fluid (i.e., coolant). The hose may be the same as described above with respect to the die assembly 100 of FIGS. 4 and 5.

In some examples, the method of cooling an extruded profile with a die assembly 100 may further include controlling a flow rate of the fluid within the internal cooling channel 111. The flow rate of fluid within the internal cooling channel 111 may be controlled in order to control the rate at which the extruded profile is cooled. Specifically, the flow rate of fluid within the internal cooling channel 111 may be controlled in order to control a rate at which a surface of the interior hollow section of the extruded profile is cooled. In some examples, the flow rate of fluid within the internal cooling channel 111 may be controlled such that a surface of the interior hollow section is cooled at a rate corresponding to a rate at which an exterior surface of the extruded profile is cooled. The exterior surface of the extruded profile may be cooled with any currently known, or later developed methods of cooling, such as quench curtains discussed above. In some examples, the flow rate of the fluid may be controlled such that fluid is only dispersed from the outlet 112 when the billet material is being extruded through the outflow end 110 of the die assembly 100.

In some examples, the method of cooling an extruded profile with a die assembly 100 may further include supplying the fluid to an outlet 112 of the internal cooling channel 111 disposed on the outflow end 110 of the die assembly 100 to cool an exterior of the extruded profile.

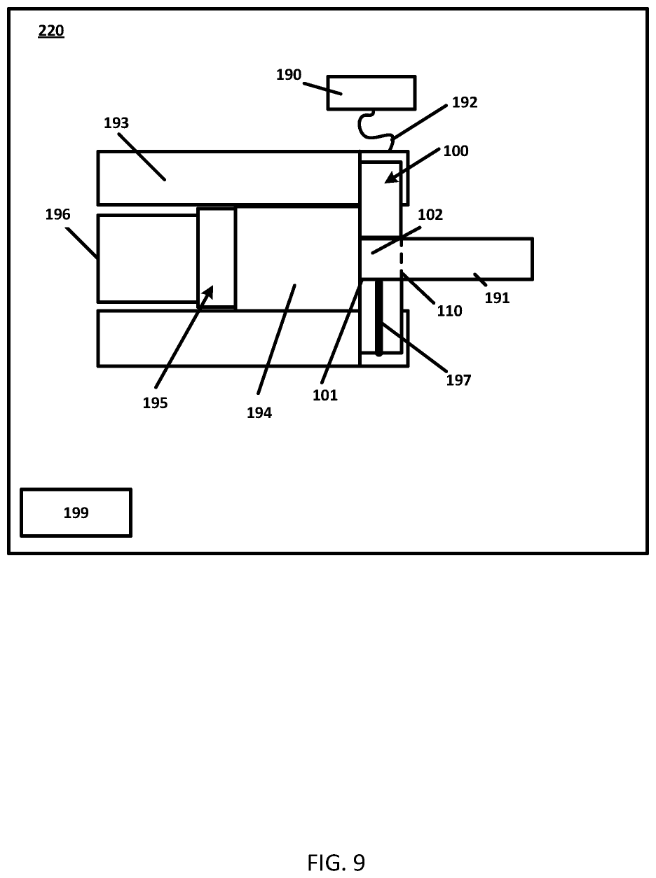

FIG. 9 illustrates a system 220 for cooling an extruded profile 191 in accordance with one example. In one example, as shown in FIG. 9, the system 220 includes a die assembly 100, and a fluid source 190. The system 220 of FIG. 9 may include the die assembly 100 described above with respect to FIGS. 1 and 2, the die assembly 120 described with respect to FIG. 3, the die assembly 130 described with respect to FIGS. 4 and 5, or the die assembly 150 described with respect to FIGS. 6 and 7. For example, the system 220 for cooling an extruded profile 191 may be used with a die assembly 100 having an inflow end 101, an outflow end 110 opposite the inflow end 101, an internal cavity 102 extending from the inflow end 101 to the outflow end 110, an internal mandrel 105 disposed within the internal cavity 102, the internal mandrel 105 having an end proximate to the outflow end 110 of the die assembly 100, and an internal cooling channel 111 within the internal mandrel 105, the internal cooling channel 111 extending from an inlet 107 disposed on an exterior surface 108 of the die assembly 100 to an outlet 112 disposed on the end 113 of the internal mandrel 105. In other examples, a different die assembly 100 may be used. The system 220 of FIG. 9 may employ the method described above with respect to FIG. 8. In other examples, a different method may be used.

Several components of the die assembly 100 and/or the extruded profile 191 are not illustrated in FIG. 9 but may be present in the system 220 as described with respect to FIG. 9. For example, the internal mandrel 105, internal cooling channel 111, bridge 106, insulator lining, and interior hollow section are not illustrated in the FIG. 9, but may be present in the system 220 as described with respect to FIG. 9.

The system 220 for cooling an extruded profile 191 further includes a fluid source 190. The fluid source 190 is in communication with the internal cooling channel 111 of the die assembly 100 and may be configured to provide a flow of fluid to, and through, the internal cooling channel 111. In some examples, a hose, tube, or other conduit may connect the fluid source 190 to the internal cooling channel 111 formed in the die assembly 100. The fluid may be the same as described above with respect to the die assembly 100 of FIGS. 1 and 2, and the method of FIG. 8. In some examples, the fluid source 190 may be a tank containing the fluid. In some examples, the fluid source 190 may be pressurized such that the fluid flows from the fluid source 190 to the internal cooling channel 111 and through the internal cooling channel 111. In other examples, the fluid source 190 may be a water line connected to a commercial building. In some examples, a supply line 192 may be disposed between the fluid source 190 and the die assembly 100. In these examples, the fluid may flow from the fluid source 190, through the supply line 192, into the die assembly 100. The fluid source 190 may be configured to supply or provide a flow of fluid through the internal cooling channel 111.

The outlet 112 of the internal cooling channel 111 may be configured to disperse the fluid into the interior hollow section of the extruded profile 191 to cool the extruded profile 191. The outlet 112 may be configured to disperse the fluid into the interior hollow section of extruded profile 191 as discussed above with respect to the method of FIG. 8. In another example, an outlet 112 of the internal cooling channel 111 may be configured to disperse the fluid onto the exterior surface of the extruded profile 191 as the extruded profile 191 exits the die assembly 100.

In some examples, the system 220 further includes an extrusion chamber 193. The extrusion chamber 193 may be coupled to the inflow end 101 of the die assembly 100. The extrusion chamber 193 may be configured to accommodate a billet 194 of material to be extruded through the die assembly 100. The extrusion chamber 193 may have a shape corresponding to the shape of the billet 194 of material. In some examples, the extrusion chamber 193 may have a cylindrical shape (i.e., circular cross section) or a rectangular prism or cuboid shape (i.e., square or rectangular cross section). Other shapes are possible. The extrusion chamber 193 may include chamber walls that surround the billet 194 of material as the billet 194 of material is fed into and extruded through the die assembly 100.

In some examples, the system 220 may further include a dummy block 195. The extrusion chamber 193 may include a dummy block 195. The dummy block 195 may be configured to force a billet 194 of material from the inside the extrusion chamber 193 through the die assembly 100 to form the extruded profile 191, the extruded profile 191 having an interior hollow section formed by the internal mandrel 105. In some examples, the extrusion chamber 193 may further include a stem 196 attached to the dummy block 195. The stem 196 may extend telescopically (i.e., linearly inside the extrusion chamber 193). As the stem 196 extends, the dummy block 195 may force the billet 194 material from inside the extrusion chamber 193 through the die assembly 100 to form the extruded profile 191.

In some examples, the die assembly 100 of the system 220 of FIG. 9 may further include a bridge 106 connecting the internal mandrel 105 to the interior surface 104 of the die assembly 100. The interior surface 104 of the die assembly 100 may be formed by the internal cavity 102 of the die assembly 100. In these examples, a portion of the internal cooling channel 111 may be formed in the bridge 106. In these examples, the fluid source 190 may be configured to provide a flow of fluid through the portion of the internal cooling channel 111 formed in the bridge 106.

In some examples, the die assembly 100 of the system 220 of FIG. 9 may further include an inlet 107 of the internal cooling channel 111 located on an exterior surface 108 of the die assembly 100. In these examples, the internal cooling channel 111 may extend through the die assembly 100, the bridge 106, and the internal mandrel 105. The fluid source 190 may be configured to provide a flow of fluid to the inlet 107 of the internal cooling channel 111. In one example, the fluid source 190 may provide the flow of fluid through the die assembly 100, the bridge 106, and the internal mandrel 105 to the outlet 112 located at the end 113 of the internal mandrel 105. In another example, the fluid source 190 may provide the flow of fluid to an outlet 112 located at the outflow end 110 of the die assembly 100.

In some examples, the system 220 for cooling an extruded profile 191 may further include a thermocouple 197 disposed within the die assembly 100. In some examples, the thermocouple 197 may be inserted into temperature sensor channels extending into the die assembly 100 from an opening on the exterior surface 108 of the die assembly 100. The thermocouple 197 may be disposed in the die assembly 100 such that the ends of the thermocouple 197 are within and/or adjacent to one of the various elements of the die assembly 100. The thermocouple 197 may be configured to determine a temperature of the element of the die assembly 100 adjacent thereto or disposed therein. For example, the ends of the thermocouple 197 may be disposed within and/or adjacent to, and configured to determine a temperature of, the die assembly 100, the bridge 106, or the internal mandrel 105.

In some examples, the system 220 for cooling an extruded profile 191 may further include a controller 199 configured to control a rate of flow of fluid from the fluid source 190. The controller 199 may control a flow rate of fluid through from the supply source, such that a flow of fluid is only supplied to the die assembly 100, and thus dispersed from the outlet 112, when billet 194 material is extruded through the outflow end 110 of the die assembly 100. In some examples, the controller 199 may be connected to an actuator and/or a valve to control the rate of flow of fluid from the fluid source 190. In some examples, the controller 199 may be connected to a pump to control the rate of flow of the fluid from the fluid source 190. The flow rate through the various cooling channels disclosed herein can be determined a number of different ways. In one example, the flow rate may be determined through off-line process planning. In another example, the flow rate may be determined by run-run adjustments in-situ (i.e., the flow rate may be determined/adjusted in between billet pushes). In yet another example, the flow rate may be determined in real time by an online process controller 199 using feedback based on die assembly 100 temperature measurements and/or profile temperature and geometry measurements.

In some examples, the controller 199 may control the rate of flow of fluid from the fluid source 190 to control the rate at which the extruded profile 191 is cooled. In some examples, the controller 199 may control the rate of flow of the fluid from the fluid source 190 to control the rate at which one or more surfaces of an interior hollow section of the extruded profile 191 are cooled. In some examples, the rate of flow of fluid from the fluid source 190 may be controlled so that a surface of an interior hollow section of the extruded profile 191 may be cooled corresponding to (e.g., at a rate similar to) the rate at which an exterior surface of the extruded profile 191 is cooled. The exterior surface of the extruded profile 191 may be cooled with any currently known or later developed method of cooling an extruded profile 191.

In some examples, the system 220 for cooling an extruded profile 191 may further include a controller 199 configured to control the dummy block 195 within the extrusion chamber 193 to force the billet 194 of material through the die assembly 100. In some examples, a single controller 199 may be configured to control the dummy block 195 and the rate of flow of fluid from the fluid source 190. In other examples, a separate controller 199 may be provided for each of the dummy block 195 and fluid source 190. In some examples, the controller 199 may control the rate at which the billet 194 material is extruded at the outflow end 110 of the die assembly 100. In some examples, the rate at which the billet 194 material is extruded through the outflow end 110 of the die assembly 100 may be controlled in conjunction with the rate at which the rate of flow of the fluid from the fluid source 190 to control the rate at which the extruded profile 191 is cooled.

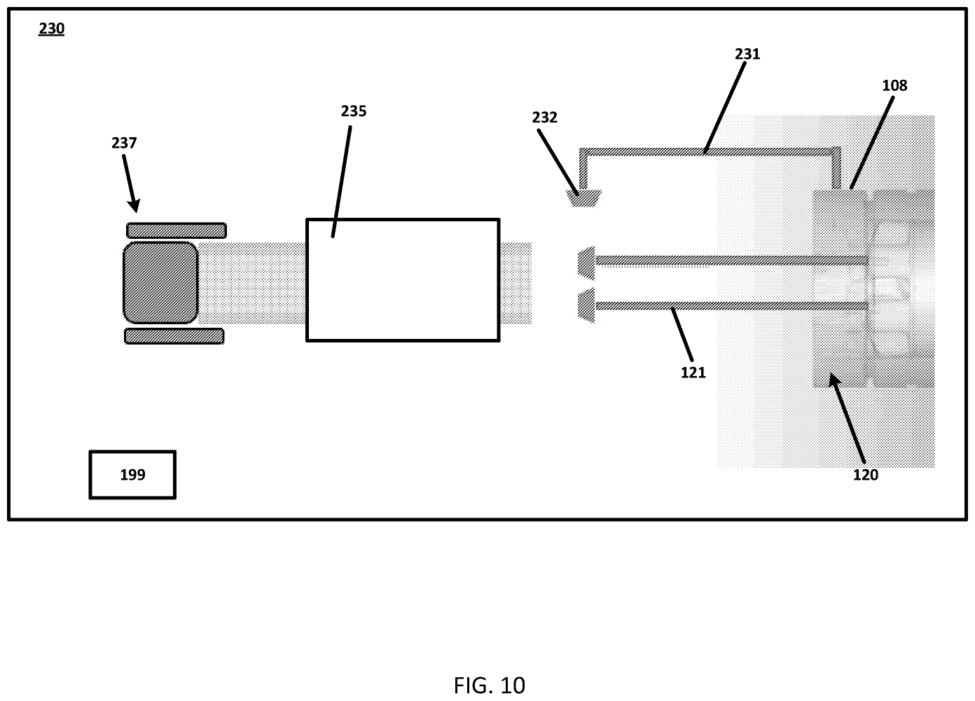

In some examples, a system for cooling an extruded profile may further include an auxiliary conduit configured to cool an exterior surface of the extruded profile. FIG. 10 illustrates a system 230 for cooling an extruded profile including conduits 121 (e.g., extending from internal mandrels 105) and an auxiliary conduit 231 including an aperture 232 configured to cool an exterior surface of an extruded profile. The system 230 and some of its respective constituent components may be the same as those discussed above with respect to the system 220 of FIG. 9. For example, the system 230 may include the fluid source 190, supply line 192, extrusion chamber 193, billet 194, dummy block 195, stem 196, and controller 199 as discussed above with respect to FIG. 9.

The system 230 as illustrated in FIG. 10 may include any of the die assemblies 100, 120, 130, and 150 described herein. As illustrated in FIG. 10, the system 230 includes the die assembly 120 including conduits 121, as described above with respect to FIG. 3. Although two conduits 121 are shown in FIG. 10, any number of conduits 121 may be used, as discussed above. The system 230 further includes an auxiliary conduit 231. The auxiliary conduit 231 may be fluidly coupled (i.e., in fluid communication) to an internal cooling channel (e.g., internal cooling channel 111) of the die assembly 120, such that fluid from a fluid source that supplies fluid to the internal cooling channels 111 also supplies fluid to the auxiliary conduit 231. In some examples, the auxiliary conduit 231 may be connected to an exterior surface 108 of the die assembly 120. In some examples, the auxiliary conduit 231 may be threadedly connected to an exterior surface 108 of the die assembly 120. In other examples, the auxiliary conduit 231 may be welded to the exterior surface 108 of the die assembly 120. In yet another example, the auxiliary conduit 231 may not be in fluid communication with internal cooling channels 111 and may not be coupled to the die assembly 120. In one example, the auxiliary conduit 231 may be in fluid communication with a fluid source, either the same fluid source 190 that supplies fluid to the internal cooling channels 111 or a separate fluid source. Therefore, in some examples, the fluid may be supplied to the auxiliary conduit 231 through the internal cooling channels 111 of the die assembly. In other examples, fluid supplied to the auxiliary conduit 231 may not flow through the internal cooling channels 111 or the die assembly 120. The auxiliary conduit 231 may extend along a direction of extrusion of the system 230. The auxiliary conduit 231 may include an aperture 232 configured to disperse, dispense, or discharge the flow of fluid onto an exterior surface of an extruded profile. In some examples, the auxiliary conduit 231 may include two or more apertures 232. In some examples, the auxiliary conduit 231 may include one or more apertures 232 disposed along the length of the auxiliary conduit 231.

In some examples, the aperture 232, or each aperture 232, may include a nozzle (e.g., nozzle 125). Various types of nozzles may be used. For example, flat fan nozzles, hollow cone nozzles, full cone nozzles, and the like may be used. In some examples, the apertures 232 may be configured to direct the flow of fluid such that the flow of fluid impacts an exterior surface of the extruded profile. In some examples, the fluid may be discharged in a directional manner, directing the flow of fluid to a particular area or location of the exterior surface of the extruded profile. For instance, the aperture 232 may be shaped to direct the flow of fluid towards a particular side of the exterior surface of the extruded profile. Certain types of nozzles or fittings may be used for this purpose as well. In examples involving a plurality of apertures 232, each of the apertures 232 may direct a flow of fluid toward a different surface (or different part of the same surface) of the exterior of an extruded profile. Although a single auxiliary conduit 231 is shown in FIG. 10, the system 230 may include additional auxiliary conduits 231 located at different points around the extruded profile. For example, a second auxiliary conduit 231 may be positioned at the bottom of FIG. 10, i.e., on the opposite side of the die assembly 120 as the auxiliary conduit 231 shown at the top of FIG. 10. In this example, the exterior surface of the extruded profile may be cooled from opposite directions by the various auxiliary conduits 231.

In some examples, the auxiliary conduit 231 and the conduits 121 may be configured to dispense the fluid at the same, or substantially the same, location along a direction of extrusion of the system 230. Accordingly, the auxiliary conduit 231 can cool an exterior surface of the extruded profile at the same, or substantially the same, location as the conduits 121 cools an interior hollow section of the extruded profile. Accordingly, the system 230 may advantageously provide more uniform cooling of the extruded profile, improving material strength of the extruded profile and reducing deformation of the extruded profile.

In some examples, the system 230 may further include a quench box 235. The quench box 235 may be disposed downstream of the die assembly 120 in the direction of extrusion of the system 230. In some examples, the quench box 235 may be disposed downstream, in a direction of extrusion, of the conduit 121 and auxiliary conduit 231. The extruded profile may travel through the quench box 235. As the extruded profile travels through the quench box 235, the quench box 235 may apply a quench curtain to an exterior surface of the extruded profile to cool the extruded profile. The quench curtain may be a spray of fluid, such as water, contacting an exterior surface of the extruded profile.

In some examples, the system 220 may further include a straightening device 237. The straightening device 237 may be located downstream, in a direction of extrusion, from the die assembly 120. In some examples, the straightening device 237 may be located downstream, in the direction of extrusion, from the conduit 121 and/or auxiliary conduit 231. In other examples, such as that shown in FIG. 10, the straightening device 237 may be located downstream, in a direction of extrusion, from the quench box 235. The straightening device 237 is configured to contact the extruded profile and straighten the extruded profile as it is extruded.

In some examples, the straightening device 237 may include a dummy die including an internal component and an external component. The internal component may have the same shape as an interior hollow section of the extruded profile. In some examples, an internal component may be provided for each interior hollow section in the extruded profile. The external component may be configured to surround or circumscribe an exterior surface of the extruded profile. In some examples, the external component may comprise multiple elements, each element configured to surround an exterior surface of the extruded profile. As the extruded profile moves in the direction of extrusion, the extruded profile may receive the internal component(s) in the interior hollow sections of the extruded profile, and the external component may contact an exterior surface of the extruded profile. Accordingly, the dummy die may apply a force to the extruded profile, straightening the extruded profile. In some examples, the dummy die may contact the extruded profile after the extruded profile has been cooled.

In some examples, the straightening device 237 comprises a clamp configured to grasp the extruded profile. In some examples, the clamp may be configured to grasp an end of the extruded profile. The clamp may be configured to pull the extruded profile in a direction of extrusion, so that tension is applied to the extruded profile. In some examples, the straightening device 237 may apply a tensile stress to the extruded profile that is less than the yield stress of the extruded profile. In some examples, the straightening device 237 may apply a tensile stress to the extruded profile close to the yield stress of the extruded profile. For example, the straightening device 237 may apply a tensile stress within 15%, 30% or 50% of the yield stress of the extruded profile. In some examples, the straightening device 237 may include multiple clamps, so as to grasp the extruded profile at multiple locations so as to apply uniform, or substantially uniform, tension to the extruded profile. In some examples, the clamp(s) may grasp the extruded profile after the extruded profile has cooled.

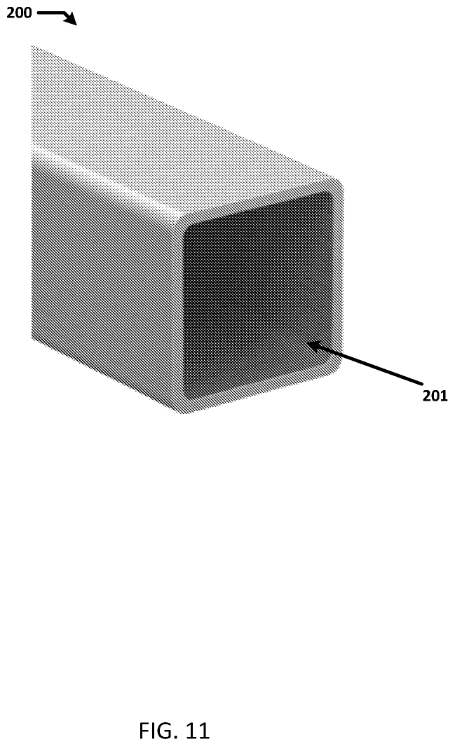

FIG. 11 illustrates a simple extruded profile 200 in accordance with one example. The extruded profile 200, as illustrated in FIG. 11, is a hollow rectangular extruded profile. The extruded profile 200 of FIG. 11 includes a single interior hollow section 201. The simple extruded profile 200 as illustrated in FIG. 11 may be extruded using the die assembly 100 as described above with respect to FIGS. 1, 2, 4, and 5, the method as described above with respect to FIG. 8, and/or the system 220 as described above with respect to FIG. 9. The extruded profile 200 as illustrated in FIG. 11 may be extruded using a die assembly including a single internal mandrel 105.

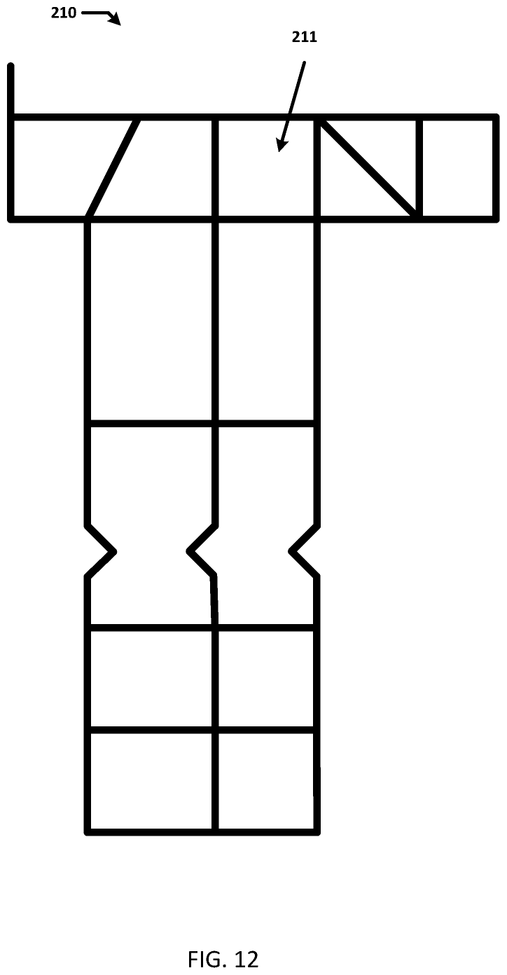

FIG. 12 illustrates a cross section of a complex extruded profile 210 in accordance with one example. The extruded profile 210, as illustrated in FIG. 12 includes a plurality of interior hollow sections 211 or channels. As shown in FIG. 12, there are fourteen (14) interior hollow sections 211. FIG. 12 may be illustrative of a complex extruded profile 210, for example, one that may be used in the automobile industry. Given the number of interior hollow sections 211, using internal cooling channels 111 to gain access to these internal profile sections allows for quenching and cooling of the various internal surfaces of the extruded profile 210, which allows for more uniform cooling of the extruded profile 210. For example, in addition to a quench curtain cooling the exterior of the profile shown in FIG. 12, the die assembly devices, methods, and systems described herein allows the inside of the multiple internal cavities to be sprayed with a cooling fluid, such as water, as the profile emerges from the extrusion die assembly, which allows the extruded profile 210 to be cooled more uniformly to avoid the problems discussed above.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clarity of understanding only, and no unnecessary limitations should be understood therefrom, as modifications within the scope of the invention may be apparent to those having ordinary skill in the art.

What is claimed is:

1. A die assembly comprising:
an inflow end;
an outflow end opposite the inflow end;
an internal cavity extending from the inflow end to the outflow end;
an internal mandrel disposed within the internal cavity, the internal mandrel having an end proximate to the outflow end of the die assembly; and
an internal cooling channel within the internal mandrel, the internal cooling channel having an outlet disposed at or near the end of the internal mandrel.

2. The die assembly of claim 1, wherein the internal cooling channel includes another outlet disposed at the outflow end of the die assembly.

3. The die assembly of claim 1, further comprising:
a bridge connecting the internal mandrel to an interior surface of the die assembly, the interior surface of the die assembly being formed by the internal cavity.

4. The die assembly of claim 3, wherein the internal cooling channel extends from an inlet disposed on an exterior surface of the die assembly to the outlet, such that the internal cooling channel extends through the die assembly, the bridge, and the internal mandrel.

5. The die assembly of claim 4, wherein:
the inlet of the internal cooling channel is configured to receive a fluid into the internal cooling channel;
the internal cooling channel is configured to allow the fluid to flow through the internal cooling channel within the die assembly, the bridge, and the internal mandrel to the outlet; and
the outlet is configured to disperse the fluid out of the internal cooling channel to cool an interior channel of an extruded profile.

6. The die assembly of claim 1, further comprising:
an insulator lining an interior of the internal cooling channel.

7. The die assembly of claim 1, wherein the die assembly includes two or more internal mandrels disposed within the internal cavity, the two or more internal mandrels being connected to an interior surface of the die assembly by one or more bridges, the interior surface of the die assembly being formed by the internal cavity.

8. The die assembly of claim 1, further comprising:
a temperature sensor channel extending into the die assembly from an opening on an exterior surface of the die assembly, the temperature sensor channel configured to accommodate a temperature sensor.

9. A method of cooling an extruded profile with a die assembly, the die assembly comprising an inflow end, an outflow end opposite the inflow end, an internal cavity extending from the inflow end to the outflow end, an internal mandrel disposed within the internal cavity, the internal mandrel having an end proximate to the outflow end of the die assembly, and an internal cooling channel within the internal mandrel, the internal cooling channel extending from an inlet disposed on an exterior surface of the die assembly to an outlet disposed at or near the end of the internal mandrel, the method comprising:
feeding a billet of material through the internal cavity of the die assembly, such that the billet of material is extruded through the outflow end of the die assembly to form the extruded profile, the extruded profile having an interior hollow section formed by the internal mandrel; and
supplying a fluid to the internal cooling channel, the internal cooling channel being configured to convey the fluid from the inlet to the outlet of the internal cooling channel, such that the fluid is dispersed at the outlet of the internal cooling channel within the internal mandrel into the interior hollow section of the extruded profile to cool the extruded profile.

10. The method of claim 9, wherein supplying the fluid comprises:
supplying the fluid through the internal cooling channel that extends through the die assembly, a bridge connecting the internal mandrel to an interior surface of the die assembly, the interior surface of the die assembly being formed by the internal cavity, and the internal mandrel.

11. The method of claim 9, wherein the fluid is dispersed uniformly into the interior hollow section of the extruded profile.

12. The method of claim 9, further comprising insulating the fluid within the internal cooling channel via an insulator lining an interior of the internal cooling channel.

13. The method of claim 9, wherein the fluid is conveyed by a plurality of internal cooling channels, each internal cooling channel of the plurality of internal cooling channels having an outlet disposed near or at the end of the internal mandrel, such that the fluid is conveyed to respective outlets of respective internal cooling channels.

14. The method of claim 13, wherein the fluid is dispersed at the respective outlets of the respective internal cooling channels into the interior hollow section of the extruded profile.

15. The method of claim 9, further comprising controlling a flow rate of the fluid within the internal cooling channel.

16. A system for cooling an extruded profile, the system comprising:
a die assembly comprising:
an inflow end;
an outflow end opposite the inflow end;
an internal cavity extending from the inflow end to the outflow end;
an internal mandrel disposed within the internal cavity, the internal mandrel having an end proximate to the outflow end of the die assembly, the internal mandrel being configured to form an interior hollow section in the extruded profile; and
an internal cooling channel within the internal mandrel, the internal cooling channel having an outlet disposed at or near the end of the internal mandrel; and
a fluid source in communication with the internal cooling channel of the die assembly and configured to provide a flow of fluid through the internal cooling channel, the outlet of the internal cooling channel being configured to disperse the fluid into the interior hollow section of the extruded profile to cool the extruded profile.

17. The system of claim 16, wherein the die assembly further comprises:
a bridge connecting the internal mandrel to an interior surface of the die assembly, the interior surface of the die assembly being formed by the internal cavity.

18. The system of claim 17, wherein the die assembly further comprises:
an inlet of the internal cooling channel located on an exterior surface of the die assembly, such that the internal cooling channel extends through the die assembly, the bridge, and the internal mandrel.

19. The system of claim 16, further comprising a thermocouple disposed in the die assembly.

20. The system of claim 16, further comprising a controller configured to control a rate of the flow of fluid from the fluid source.

21. The system of claim 16, further comprising a controller configured to control a dummy block within an extrusion chamber to force a billet of material through the die assembly, the controller configured to control a rate at which the billet of material is forced through the die assembly by the dummy block.

22. A die assembly comprising:
an inflow end;
an outflow end opposite the inflow end;
an internal cavity extending from the inflow end to the outflow end;
an internal mandrel disposed within the internal cavity, the internal mandrel having an end proximate to the outflow end of the die assembly;
an internal cooling channel within the internal mandrel, the internal cooling channel having an outlet disposed at or near the end of the internal mandrel; and
a conduit fluidly coupled to the outlet and extending from the end of the internal mandrel, the conduit including an opening.

23. The die assembly of claim 22, wherein the opening is disposed at or near a distal end of the conduit.

24. The die assembly of claim 22, wherein the opening is disposed along a length of the conduit.

25. The die assembly of claim 22, further comprising:
a bridge connecting the internal mandrel to an interior surface of the die assembly, the interior surface of the die assembly being formed by the internal cavity.

26. The die assembly of claim 25, wherein the internal cooling channel extends from an inlet disposed on an exterior surface of the die assembly to the outlet, such that the internal cooling channel extends through the die assembly, the bridge, and the internal mandrel.

27. The die assembly of claim 26, wherein:
the inlet of the internal cooling channel is configured to receive a fluid into the internal cooling channel;
the internal cooling channel is configured to allow the fluid to flow through the internal cooling channel within the die assembly, the bridge, and the internal mandrel to the outlet and the conduit; and
the conduit is configured to allow the fluid to flow from the outlet through an internal space of the conduit and disperse the fluid out of the internal space to cool an interior hollow section of an extruded profile.

28. The die assembly of claim 22, wherein the opening includes a nozzle.

29. The die assembly of claim 22, wherein an internal space of the conduit is converging or diverging.

30. The die assembly of claim 22, wherein the opening is configured to control a flow rate and angle at which a fluid impinges on a specific surface of an interior hollow section of an extruded profile.

31. The die assembly of claim 22, wherein the conduit has a non-circular cross section.

32. A system for cooling an extruded profile, the system comprising:
a die assembly comprising:
an inflow end;
an outflow end opposite the inflow end;
an internal cavity extending from the inflow end to the outflow end;
an internal mandrel disposed within the internal cavity, the internal mandrel having an end proximate to the outflow end of the die assembly, the internal mandrel being configured to form an interior hollow section in the extruded profile;
an internal cooling channel within the internal mandrel, the internal cooling channel having an outlet disposed at or near the end of the internal mandrel; and
a conduit fluidly coupled to the outlet and extending from the end of the internal mandrel, the conduit including an opening;
an auxiliary conduit connected to an exterior surface of the die assembly and extending in a direction of extrusion, the auxiliary conduit fluidly coupled to the internal cooling channel and including an aperture; and
a fluid source in communication with the internal cooling channel of the die assembly and the auxiliary conduit, the fluid source being configured to provide a flow of fluid through the internal cooling channel and the auxiliary conduit,
wherein the opening of the conduit is configured to disperse the fluid into the interior hollow section of the extruded profile to cool the extruded profile and wherein the aperture of the auxiliary conduit is configured to disperse the fluid onto an exterior of the extruded profile to cool the extruded profile.

33. The system of claim 32, wherein the die assembly further comprises:
a bridge connecting the internal mandrel to an interior surface of the die assembly, the interior surface of the die assembly being formed by the internal cavity.

34. The system of claim 33, wherein the die assembly further comprises:
an inlet of the internal cooling channel located on an exterior surface of the die assembly, such that the internal cooling channel extends through the die assembly, the bridge, and the internal mandrel.

35. The system of claim 32, further comprising:
a quench box configured to cool an exterior surface of the extruded profile, the quench box disposed downstream in a direction of extrusion from the die assembly; and
a straightening device located downstream in the direction of extrusion from the quench box, the straightening device configured to contact and straighten the extruded profile.

36. The system of claim 35, wherein the straightening device comprises a dummy die including an internal component configured to contact a surface of the interior hollow section of the extruded profile and an external component configured to contact the exterior surface of the extruded profile.

37. The system of claim 35, wherein the straightening device comprises a clamp configured to grasp the extruded profile and pull the extruded profile in the direction of extrusion, such that tension is applied to the extruded profile.
